(19) United States
(12) Patent Application Publication
(10) Pub. No.: US 2011/0023834 A1
(43) Pub. Date: Feb. 3, 2011

(54) INTERNAL COMBUSTION ENGINE WITH VARIABLE COMPRESSION RATIO

(76) Inventor: Michael von Mayenburg, (US)

Correspondence Address: KLARQUIST SPARKMAN, LLP, 121 SW SALMON STREET, SUITE 1600, PORTLAND, OR, 97204, US

(21) Appl. No.: 12/901,434

(22) Filed: Oct. 8, 2010

Related U.S. Application Data
(63) Continuation-in-part of application No. 12/011,494, filed on Jan. 25, 2008.
(60) Provisional application No. 60/936,741, filed on Jun. 22, 2007.
(60) Provisional application No. 60/958,352, filed on Jul. 3, 2007.
(60) Provisional application No. 61/003,498, filed on Nov. 16, 2007.
(60) Provisional application No. 61/388,906, filed on Oct. 1, 2010.
(60) Provisional application No. 61/290,682, filed on Dec. 29, 2009.

(51) Int. Cl. F02B 75/04

(52) U.S. Cl. 123/48 B

(57) ABSTRACT

A piston coupler, such as a piston pin, is pivotally coupled to a piston such that the piston can pivot about a first axis relative to the piston pin. A connecting rod is coupled to the coupler for pivoting about a second axis. The relative positions of the first and second axes can be shifted by pivoting an eccentric portion of the piston pin to thereby vary the compression ratio of a piston cylinder within which the piston slides. An adjuster retainer is coupled to the piston or to the connecting rod. A combustion ratio adjuster (CRA) is coupled to the adjuster retainer. A biasing member couples the CRA to the piston pin. The CRA being selectively pivoted from first to second positions in response to shifting of a pivot member. Pivoting the CRA loads the biasing member with energy for use in turning the piston pin to adjust the compression ratio. The CRA is pivoted as the piston approaches the bottom dead center (BDC) position and the piston pin is turned after the piston travels away from the BDC position.

### CROSS-REFERENCE TO RELATED APPLICATIONS

This application claims the benefit of U.S. Provisional Application No. 61/388,906, titled “Internal Combustion Engine with Variable Compression Ratio”, filed Oct. 1, 2010, and also claims the benefit of U.S. Provisional Application No. 61/290,682, titled “Internal Combustion Engine With Variable Compression Ratio”, filed Dec. 29, 2009, and is a continuation-in-part of U.S. application Ser. No. 12/011,494, titled “Internal Combustion Engine with Variable Compression Ratio,” filed Jan. 25, 2008, which claims the benefit of U.S. Provisional Application No. 61/003,498, titled “Internal Combustion Engine With Variable Compression Ratio,” filed Nov. 16, 2007, and claims the benefit of U.S. Provisional Application No. 60/936,741, titled “Internal Combustion Engine With Variable Compression Ratio” and filed Jun. 22, 2007, and also claims the benefit of U.S. Provisional Application No. 60/958,352, titled “Internal Combustion Engine With Variable Compression Ratio” and filed Jul. 3, 2007; all of which are incorporated herein by reference.

### FIELD

The technology disclosed herein relates to methods and apparatus for adjusting the compression ratio of an internal combustion engine, such as for gasoline and diesel fueled engines.

### BACKGROUND

Gasoline engines are typically designed so that under full load (open throttle) no uncontrolled combustion (knocking) occurs which limits the compression ratio. Under throttled conditions, the gasoline engine is under compressed which can reduce engine efficiency. Diesel engines are typically over compressed to enhance starting in cold conditions. Diesel engines that have warmed up would be more efficient if they had a lower compression ratio. Thus, a variable compression ratio engine can be operated under various operating conditions to vary the engine compression so as to, for example, increase engine efficiency. A need exists for an improved variable compression ratio engine and related methods.

### SUMMARY

In accordance with one embodiment of an internal combustion engine, a piston coupler is pivotable about a first axis and pivotally couples a piston to a connecting rod with the piston being slidable in an associated piston cylinder in response to rotation of a crank shaft coupled to the connecting rod. The piston coupler can take a variety of forms and can comprise various forms of a piston pin. The piston is reciprocated between top dead center (TDC) and bottom dead center (BDC) positions. The piston coupler comprises a first coupler portion pivotally coupled to the piston such that the piston is pivotable about a first axis and a second coupler portion threadedly coupled to the connecting rod such that the connecting rod is pivotable about a second axis. The threaded coupling resists relative pivoting of the piston coupler and connecting rod. The second coupler portion comprises an eccentric portion operable such that pivoting of the piston coupler about the first axis from a first coupler position to a second coupler position pivots the eccentric portion from a first eccentric position to a second eccentric position and shifts the second axis relative to the first axis to thereby vary the compression ratio of the associated piston cylinder. The assembly can also comprise a pivot member engager, such as in the form of a compression ratio adjuster frictionally coupled, such as by an adjuster retainer, to the piston coupler. The adjuster retainer can be coupled to the piston or to the piston rod. A biasing member, such as a coil spring, can be coupled to the piston coupler and to the compression ratio adjuster. As another aspect of the embodiment, a pivot member is provided and comprises a compression ratio adjuster engager selectively movable from a first adjuster engager position to a second adjuster engager position to adjust the compression ratio of the engine. The pivot member and more specifically the compression ratio adjuster engager is positioned to engage the compression ratio adjuster so as to pivot the compression ratio adjuster relative to the piston coupler from a first compression ratio adjuster position to a second compression ratio adjuster position and so as to load the biasing member with torsional biasing energy as the piston approaches the bottom dead center position and in response to such movement of the pivot coupler engager. As another aspect of this embodiment, the compression ratio adjuster engager is disengaged from the compression ratio adjuster as the piston travels away from bottom dead center position. As the connecting rod reaches a relatively low force position in its travel (where compression and tension forces on the connecting rod are reduced, a torsional biasing force applied by the biasing member to the piston coupler overcomes forces resisting relative pivoting of the eccentric portion of the piston coupler and connecting rod. When this occurs, the eccentric portion is pivoted to a new position to thereby vary the compression ratio. As a result, in this embodiment, pivoting of the eccentric portion in response to a change in position of the compression ratio adjuster is delayed until such time as the forces on the connecting rod are reduced from the level of such forces at the bottom dead center position of the piston and the biasing force pivots the piston coupler.

In accordance with a further aspect of any one or more of the embodiments disclosed herein, the pivot member can comprise a dampening apparatus for dampening the forces that arise as the compression ratio adjuster engages the compression ratio adjuster engager. Force absorbing resilient material coupling the pivot member to the pivot member supporting structure can be used for this purpose. Alternatively, a leaf spring force absorbing structure can be included in the pivot member for engaging the compression ratio adjuster (alternatively for engaging the compression ratio adjuster engager in certain embodiments).

In accordance with another aspect of any one or more of the preceding embodiments, a pivot member can be pivotable about a pivot member axis for pivoting movement from first to second pivot member positions to move the compression ratio adjuster engager from first to second positions so as to result in corresponding movement of the compression ratio adjuster from first to second compression ratio adjuster positions to thereby cause movement of the eccentric portion of the piston coupler to vary the compression of the engine.

As another aspect of any one or more of the preceding embodiments, the compression ratio adjuster can comprise at least one pivot member engagement surface which, for example, can be flat or planar, and the pivot member can comprise a compression ratio adjuster engager with at least one adjuster engagement surface, that can also be flat or planar.

In a more specific aspect of any one or more of the preceding embodiments, the pivot member is pivotable about a pivot member axis and comprises two pivot member engagement surfaces respectively positioned at opposite sides of the first axis and wherein there is a first set of two adjuster engagement surfaces on opposite sides of the pivot member axis.

In accordance with another aspect of any one or more of the preceding embodiments, a plurality of piston cylinders provided, each with an associated piston, piston coupler, connecting rod, adjuster retainer, compression ratio adjuster and pivot member. A common pivot member can be provided to engage the pivot member engagement surfaces of compression ratio adjusters associated with the pistons in the respective first and second piston cylinders. A first bracket positioned at least in part in the first cylinder and a second bracket positioned at least in part within the second cylinder can be used to support respective end portions of the common pivot member. A first set of two adjuster engagement surfaces can be provided at one end portion of the common pivot member and a second set of two pivot coupler engagement surfaces can be provided at the opposite end portion of the common pivot member.

In accordance with a further aspect of any one or more of the preceding embodiments, the piston coupler can comprise a piston pin pivotable about the first axis with exemplary forms of piston pins being described in greater detail below. The piston pin can comprise an eccentric portion threadedly coupled to the associated connecting rod. For example, a central portion of the piston pin, or a portion of the piston pin intermediate the ends of the piston pin, can comprise the eccentric portion and can be threaded to the associated connecting rod. In one specific aspect of any one or more of the preceding embodiments, a piston pin can include internal cavities. These internal cavities can include a first cavity at one end portion of the piston pin that can be at least in part conical, a second cavity at an opposite end portion of the pivot pin that can also be at least in part conical, and an internal passageway extending therebetween. These passageways can be shaped and dimensioned and positioned to provide a homogeneous bending line in response to the application of force by the piston to the piston pin and the counterforce applied by the connecting rod to the piston pin during operation of an engine.

In accordance with another aspect of any one or more of the preceding embodiments, the piston coupler comprises a piston pin. A piston associated with a cylinder can comprise a body having an upper cylindrical piston ring supporting portion of a first diameter and a lower body portion sized to create a compression ratio adjuster receiving space between the lower body portion and the associated cylinder. One end portion of the compression ratio adjuster can extend outwardly from the lower body portion into the compression ratio adjuster and can comprise the pivot member engagement surface or surfaces. As yet another aspect of any one or more of the preceding embodiments, the pivot members can be selectively driven to cause pivoting of the pivot members to thereby vary the compression ratio of the engine. In a specific example, a motor can be coupled to a worm gear which operably engages a pivot member to pivot the pivot member between various positions to adjust the compression ratio to a plurality of values depending upon the position to which the pivot member has been pivoted. A single motor can be coupled to a plurality of pivot member drivers, such as to plural worm gears, such as a respective worm gear for driving each pivot member. As another aspect of any one or more of the preceding embodiments, a worm gear associated with a pivot member can engage a pivot member to restrict movement of a pivot member in either direction along a pivot member axis about which the pivot member can be pivoted. In a more specific aspect, the pivot member can define a recess extending in a direction perpendicular to the pivot member axis with the worm gear being positioned at least partially in the recess and engaging the pivot member to restrict movement of the pivot member in either direction along the pivot member axis.

In accordance with an aspect of any one or more of the preceding embodiments, pivoting of the pivot member can be limited to be within predetermined limits such as by configuring a worm gear drive for the pivot member. In addition, a mechanism can be provided for limiting the extent of pivoting of the pivot coupler about the first axis to be within a predetermined limit.

In accordance with yet another aspect of any one or more of the preceding embodiments, a piston coupler retainer assembly can be coupled to the piston coupler to apply a retention force to selectively resist pivoting of the piston coupler. The piston coupler retainer assembly can comprise a compression ratio adjuster in combination with an adjuster retainer and biasing member. The piston coupler retainer assembly can also limit pivoting of the pivot coupler about the first axis to be within a predetermined limit. The piston coupler retainer assembly can in effect comprise a friction brake that limits pivoting of the piston coupler except in response to movement of the compression ratio adjuster by the pivot member. The adjuster retainer in one form can be positioned at least partially within an adjuster retainer receiving cavity of the piston coupler. The adjuster retainer can also define a compression ratio adjuster receiving cavity that can comprise, for example, an arcuate, partially conical, or frustoconical adjuster retainer surface (or first braking or first friction surface). The compression ratio adjuster can comprise an adjuster retainer engaging surface (or second braking or second friction surface). The adjuster retainer engaging surface can be, for example, partially conical, frustoconical or arcuate. The compression ratio adjuster in one form can be inserted at least partially into the compression ratio adjuster receiving cavity with at least a portion of the engaging surface frictionally engaging at least a portion of the adjuster retainer surface. In one embodiment, the adjuster retainer is mounted to the associated piston and desirably fixedly mounted to the associated piston. In an alternative embodiment, the adjuster retainer is coupled to the associated piston pin and to the associated connecting rod, such as by a flange or finger configured to engage a slot provided in the connecting rod. The first friction surface can thereby comprise a portion of the adjusting retainer. The second friction surface can thereby comprise a portion of the compression ratio adjuster.

The first and second friction surfaces in accordance with any one or more of the preceding embodiments can be axially aligned with the axis of the associated piston pin or coupler. A biasing member, such as a coil spring coupled to the piston pin and to the second friction surface defining member or otherwise to the compression ratio adjuster, exerts an axial force that urges the second friction surface toward the first friction surface. When the compression ratio adjuster is turned by the pivot member, the biasing member is loaded with rotational or torsional biasing energy that is applied as a torsional or rotational force to the piston pin to cause the pivoting of the eccentric when tension and compression forces in the associated connecting rod are reduced. Separate biasing members, such as separate springs, can be used to apply the axial force and the rotational biasing force, if desired.

As a still further aspect of any one or more of the preceding embodiments, an internal combustion engine is provided wherein a piston cylinder has a longitudinal centerline and wherein the maximum eccentricity is defined as E and corresponds to the maximum offset between the first and second axes, wherein an origin of a reference coordinate system is at the intersection of the longitudinal centerline of the at least one piston cylinder and a bottom dead centerline corresponding the second axis when the second axis is in the bottom dead center position, wherein the Z dimension is along the longitudinal center line of the piston cylinder from the origin and the X dimension is along the bottom dead centerline from the origin, wherein the pivot member axis is parallel to the first axis and, wherein the pivot member axis intersects an area wherein X is from −0.5E to −0.8E and Z is from −0.25E to 0.25E.

As yet another aspect of any one or more of the preceding embodiments, an internal combustion engine comprises at least one piston cylinder with a longitudinal centerline, wherein the longitudinal centerline is positioned between a first line parallel to the longitudinal centerline that intersects the first axis and a second line parallel to the longitudinal centerline that intersects the second axis when the eccentric portion is pivoted to the maximum allowed extent.

As a further aspect of any one or more of the preceding embodiments, an internal combustion engine is provided wherein the maximum eccentricity is defined as E and corresponds to the maximum offset between the first and second axes arising from pivoting the eccentric portion, wherein the piston coupler comprises a piston pin comprising first and third portions and a second portion intermediate the first and third portions, the first and third portions having longitudinal centerlines that are aligned with the first axis, the second portion comprising the eccentric portion and having a longitudinal center line that is aligned with the second axis, the first, second and third portions comprising right cylindrical surfaces, the second portion having a right cylindrical surface of a first diameter defined as R_{CR}, one of the first and third portions having a right cylindrical surface of a diameter R₁, wherein R₁≧(R_{CR}+E), and the other of the first and third portions having a right cylindrical surface of a diameter R₂, wherein R₂≦(R_{CR}−E).

As a still a further specific aspect of any one or more of the preceding embodiments, an internal combustion engine is provided wherein there are first and second of said piston cylinders, a respective associated first piston slidably received by the first of said piston cylinders and a respective associated second piston slidably received by the second of said piston cylinders, a respective connecting rod and piston coupler associated with and coupled to said first piston, a respective connecting rod and piston coupler associated with and coupled to the second piston, an adjuster retainer and a compression ratio adjuster associated with the piston coupler associated with the first piston, and adjuster retainer and a compression ratio adjuster associated with the second piston, and wherein there is a common pivot member for engaging the respective compression ratio adjusters associated with the first and second pistons. The common pivot member can comprise a first set of two adjuster engagement surfaces for engaging two pivot member engagement surfaces of the compression ratio adjuster associated with the first piston and a second set of two pivot coupler engagement surfaces for engaging two pivot member engagement surfaces of a compression ratio adjuster associated with the second piston. The common pivot member can comprise a first pivot member end portion extending into a first region defined by the first cylinder and a second pivot member end portion extending into a second region defined by the second cylinder. A first bracket can be coupled to the first cylinder in a position to pivotally support the first pivot member end portion and a second bracket can be coupled to the second cylinder in a position to pivotally support the second pivot member end portion. The first and second brackets can be fastened together with a portion of the first cylinder and a portion of the second cylinder positioned between the first and second brackets. The first and second brackets can be configured to provide clearance for the respective pivot member engagement surfaces and adjuster engagement surfaces to engage one another. The pivot members can be dampened pivot members.

As a more specific aspect of any one or more of the preceding embodiments, each of the first and second friction surfaces of respective adjuster retainers and compression ratio adjusters can be at least partially arcuate, conical or frustoconical. The piston coupler can comprise a piston pin with a first end portion comprising a first cavity. An adjuster retainer can be positioned at least partially within the first cavity. The compression ratio adjuster can be inserted at least partially into a cavity defined by the adjuster retainer. The friction surfaces can be respective portions of an interim surface of the cavity defined by the adjuster retainer and a portion of the exterior surface of the compression ratio adjuster that is inserted into such adjuster retainer cavity. The piston pin can comprise a second end portion that defines a second cavity that is at least partially conical. An internal cavity can be provided that interconnects the second end portion cavity and the brake receiving cavity. The internal cavity, the second end portion cavity and the first cavity can be shaped and dimensioned to achieve a homogenous bending line in response to the application of force by the piston to the piston pin and the counterforce applied by the connecting rod during operation of the engine. As yet another aspect of an embodiment, the compression ratio adjuster can comprise a stop portion positioned to engage the piston coupler to limit the extent of pivoting of the piston coupler to within a predetermined limit.

The invention encompasses all novel and non-obvious assemblies, sub-assemblies and individual elements, as well as method acts, that are novel and non-obvious and that are disclosed herein. The embodiments described below to illustrate the invention are examples only as the invention is defined by the claims set forth below. In this disclosure, the term “coupled” and “coupling” encompasses both a direct connection of elements as well as the indirect connection of elements through one or more other elements. Also, the terms “a” and “an” encompass both the singular and the plural. For example, if “an” element or “a” element is referred to, this includes one or more of such elements. For example, if a plurality of specific elements of one type present, there is also “an” element of the type described. The invention is also not limited to a construction which contains all of the features described herein.

Adjustable compression ratio engines can be operated to improve the efficiency of the engine by varying the compression ratio appropriately.

### BRIEF DESCRIPTION OF THE DRAWINGS

FIG. 1 is a vertical sectional view of an embodiment of an internal combustion engine with exemplary features allowing the variation of the compression ratio of pistons of the engine.

FIG. 2 is a side elevational view of an exemplary piston that can be included in the embodiment of FIG. 1.

FIG. 3 is a vertical sectional view of the piston of FIG. 2 taken along line 3-3 of FIG. 2.

FIG. 4 is a top view of a piston coupler in the form of a piston pin in accordance with an embodiment thereof.

FIG. 4A is an end view of the piston pin of FIG. 4 looking toward the right end of the FIG. 4 piston pin.

FIG. 4B depicts the piston pin of FIG. 4 with exemplary radiuses indicated for three different sections of the pin of the embodiment of FIG. 4 and with an eccentricity E also indicated in FIG. 4B.

FIG. 4C illustrates yet another embodiment of an exemplary piston pin.

FIG. 5 is a horizontal sectional view through the piston pin of FIG. 4.

FIG. 5A is an end view looking toward the right end of the piston pin in FIG. 5 taken as if the piston pin of FIG. 5 had not been sectioned.

FIG. 5B is an end view looking forward the left hand end of the piston pin of FIG. 5 taken as if the piston pin of FIG. 5 has not been sectioned.

FIG. 5C is a sectional view through yet another form of pivot pin similar to the sectional view of FIG. 5, with FIG. 5C illustrating one internal cavity within the piston pin of a different configuration than the corresponding cavity shown in FIG. 5.

FIG. 5D illustrates an homogeneous bending line achievable using the design for a piston pin of FIG. 5C in response to the application of force by the piston to the piston pin (force lines Fp, Fp) and the counterforce (indicated by F_{cr}) applied by the connecting rod during operation of the engine.

FIG. 6 illustrates a portion of an exemplary friction brake that can be used to resist pivoting motion of the piston pin of FIG. 5 relative to the piston after the piston pin has been pivoted to achieve a desired engine compression.

FIG. 6A is a vertical sectional view taken along line 6A-6A of FIG. 6.

FIG. 6B is a vertical sectional view taken along line 6B-6B of FIG. 6A.

FIG. 6C is a vertical sectional view taken along line 6C-6C of FIG. 6A.

FIG. 6D is a vertical sectional view taken along line 6D-6D of FIG. 6C.

FIG. 7 is a horizontal sectional view looking downwardly from the top of a piston of the form shown in FIG. 2, taken along line 7-7 of FIG. 2, and with the piston pin of FIG. 4 assembled with the piston.

FIG. 7A is similar to FIG. 7 without the piston pin being sectionalized and adding a portion of a connecting rod and connecting rod supporting bushing to FIG. 7A.

FIG. 7B is a sectional view similar to FIG. 7 including an un-sectioned view of a pivot pin of the form shown in FIG. 4C, it being understood that the pin of FIG. 4C can include cavities such as of the form shown in FIG. 4, FIG. 7 and FIG. 5C.

FIG. 8 illustrates a vertical sectional view of one exemplary form of a pivot member configured to engage and pivot a pivot coupler, such as a piston pin, to vary the compression ratio of a piston cylinder

FIG. 8A is a sectional view taken along lines 8A-8A of FIG. 8, but as if the pivot member of FIG. 8 had not been sectioned.

FIG. 9 is a top view of an exemplary form of pivot member that can be used to pivot piston pins of more than one piston to vary the compression ratio of the piston cylinders of such pistons.

FIG. 9A is a vertical sectional view of the pivot member of FIG. 9, taken along line 9A-9A of FIG. 9.

FIG. 9B is a vertical sectional view through the pivot member of FIG. 9, taken along 9B-9B of FIG. 9.

FIGS. 10 and 11 are horizontal sectional views of support brackets (shown installed in the internal combustion engine of FIG. 13) that can be used to support a pivot member, such as a pivot member of the form shown in FIG. 9 with FIG. 10 being taken along line 10-10 of an un-sectioned bracket of the form shown in FIG. 10A and FIG. 11 being taken along line 11-11 of an un-sectioned bracket of the form shown in FIG. 11A.

FIGS. 10A and 11A are vertical sectional views through un-sectioned brackets of the type shown in FIGS. 10 and 11, taken along line 10A-10A of FIG. 10 for FIG. 10A and along line 11A-11A of FIG. 11 for FIG. 11A.

FIG. 12 is a side elevational view of an entire bracket of the form shown in part in FIG. 10 and of the type installed in the engine of FIG. 13.

FIG. 12A is a perspective view of a bracket of the form shown in part in FIG. 11.

FIG. 13 is a vertical cross-sectional view through a portion of an internal combustion engine of the type shown in FIG. 1, illustrating exemplary pivot members having end portions projecting into lower regions of respective cylinder areas.

FIG. 14 is a transverse vertical sectional view of the internal combustion engine of FIG. 1.

FIGS. 14A, 14B and 14C illustrate an exemplary pivot member drive mechanism, in this case a worm gear guide mechanism for pivoting exemplary pivot members.

FIGS. 15A, 15B, 15C and 15D schematically illustrate pivoting of a pivot member engaging portion of a piston pin to shift the axis of the connecting rod to piston coupling relative to the axis of pivoting of the piston, to vary the stroke of an engine as the piston moves toward a bottom dead center position.

FIGS. 16A and 16B illustrate an exemplary relative position of the longitudinal centerline of a piston to fall between the maximum and minimum eccentric positions of the piston rod connection.

FIG. 17 schematically illustrates a desirable location for a pivot axis of an exemplary pivot member with engagement surfaces shown as flat surfaces aligned in this example along a bottom dead center position of the piston.

FIG. 18 illustrates an exemplary motor operable to control the pivoting of pivot members to vary the compression of the pistons and also illustrates exemplary control signals derived from exemplary engine parameters, one or more of which can be used to control the motor to thereby control the pivoting of pivot members and the compression ratio of the pistons.

FIG. 19 is an end view of a portion of a connecting rod that threadedly engages an eccentric of a piston pin.

FIG. 20 is a partially vertical sectional view of the connecting rod of FIG. 19 and piston pin assembly with the connecting rod rotated ninety degrees from the position shown in FIG. 19.

FIG. 21 is an enlarged view of portions of the thread on the eccentric of the piston pin of FIG. 20.

FIG. 22 schematically illustrates expected connecting rod forces for an exemplary engine operating at a speed of 4,000 revs/minute and at 40 percent load. The connecting rod forces pass through zero four times during the four strokes (intake, compression, working, exhaust) of the engine cycle in this example.

FIGS. 23 through 25 schematically illustrate tension and compression forces on the connecting rod at selected piston positions during a working cycle of a piston.

FIGS. 26 and 27 illustrate representative cross-sections of a coil spring that can be used as a biasing member in embodiments described herein.

FIG. 28 is a sectional view of one embodiment of piston pin with a central eccentric with threads for threadedly coupling to a connecting rod and also illustrating bearings or bushings in position for positioning on respective end portions of the piston pin.

FIG. 29 is a top view of the piston pin of the embodiment of FIG. 28.

FIG. 30 is an end view of the piston pin of the embodiment of FIG. 28 illustrating the interconnection of a separate eccentric portion of the pin of FIG. 28 with the central portion of the pin of FIG. 28.

FIG. 31 is a view of the eccentric portion of the piston pin of FIG. 28.

FIG. 32 is a sectional view of an alternative form of a piston pin, similar to the embodiment of FIG. 28, except that the eccentric and other portions of the piston pin are shown as being of a homogenous monolithic one-piece construction.

FIG. 33 is a top view of the piston pin of the embodiment of FIG. 32.

FIG. 34 is an end view of the piston coupler of the embodiment of FIG. 32.

FIG. 35 is a sectional view through an alternative form of a piston pin, having a threaded central eccentric portion.

FIG. 36 is a top view of the piston pin of the embodiment of FIG. 35.

FIG. 37 is an end view of the piston pin of the embodiment of FIG. 35.

FIG. 38 is a front view of one form of an adjuster retainer shown as a friction cone with mounts for connecting the friction cone to an associated piston.

FIG. 39 is a vertical sectional view through the adjuster retainer of FIG. 38, taken along line 39-39 of FIG. 38.

FIG. 40 is a rear view of the adjuster retainer of FIG. 38.

FIG. 41 is a front view of one form of a compression ratio adjuster suitable for use in embodiments.

FIG. 42 is a vertical sectional view of the compression ratio adjuster of FIG. 41 taken along line 42-42 of FIG. 41.

FIG. 43 is a rear view of the compression ratio adjuster of FIG. 41.

FIGS. 44 through 47 are various views of one form of a spring that can be used as a biasing member for the compression ratio adjuster.

FIG. 48 is a vertical sectional view through a piston comprising an adjuster retainer, a compression ratio adjuster and a biasing spring, together with a piston pin threadedly coupled to a connecting rod. For purposes of illustration, FIG. 48 utilizes a piston pin like the piston pin of the embodiment of FIG. 28.

FIG. 49 is a vertical sectional view through a portion of the FIG. 48 embodiment.

FIG. 50 is a horizontal sectional view through a portion of the FIG. 48 embodiment.

FIG. 51 illustrates one embodiment of a piston pin, utilizing needle bearings.

FIG. 52 illustrates an end view of an exemplary needle bearing taken along line A-A of FIG. 51.

FIG. 53 is a vertical sectional view through one form of a pivot member or turning member comprising dampening components.

FIG. 54 is an end view of the turning member of FIG. 53.

FIG. 55 is a cross-sectional view of an embodiment of a pivot member or turning member utilizing a leaf spring assembly for dampening purposes.

FIG. 56 is an end view of the pivot member of FIG. 55.

FIG. 57 is a top view of an exemplary leaf spring assembly that can be included in the pivot member embodiment of FIG. 55.

FIG. 58 is an end view of one form of compression ratio adjuster, which also illustrates a portion of a biasing spring coupled thereto, and showing the compression ratio adjuster shifted to a second position in dashed lines.

FIG. 59 is a vertical sectional view through the adjuster of FIG. 58 with the spring removed therefrom.

FIG. 60 illustrates an end view of an exemplary adjuster retainer with a connecting rod engaging structure that can comprise a flange or finger.

FIG. 61 is a vertical sectional view of the adjuster retainer of FIG. 60, taken along line 61-61 of FIG. 60.

FIG. 62 is a top view of the adjuster retainer of FIG. 60.

FIG. 63 illustrates an adjuster retainer of the form shown FIG. 60 installed in one end of a piston pin.

FIG. 64 illustrates a modified form of an adjuster retainer installed in one end of a piston pin.

FIG. 65 is a vertical sectional view through a portion of a connecting rod having a threaded central opening for threadedly receiving an eccentric portion of a piston pin and also showing a portion of a slot for receiving a coupling structure of the adjuster retainer member.

FIG. 66 is an end view of the connecting rod of FIG. 65, illustrating an exemplary slot in greater detail. It should be noted that other mating arrangements apart from an engagement slot can be used.

FIG. 67 is a horizontal sectional view through a portion of the connecting rod of FIG. 64, taken along line A-A of FIG. 66.

FIG. 68 is an end view of a piston including a compression ratio adjuster and adjuster retainer of the form shown in FIG. 60.

FIG. 69 is a vertical sectional view through the piston assembly of FIG. 68.

### DETAILED DESCRIPTION

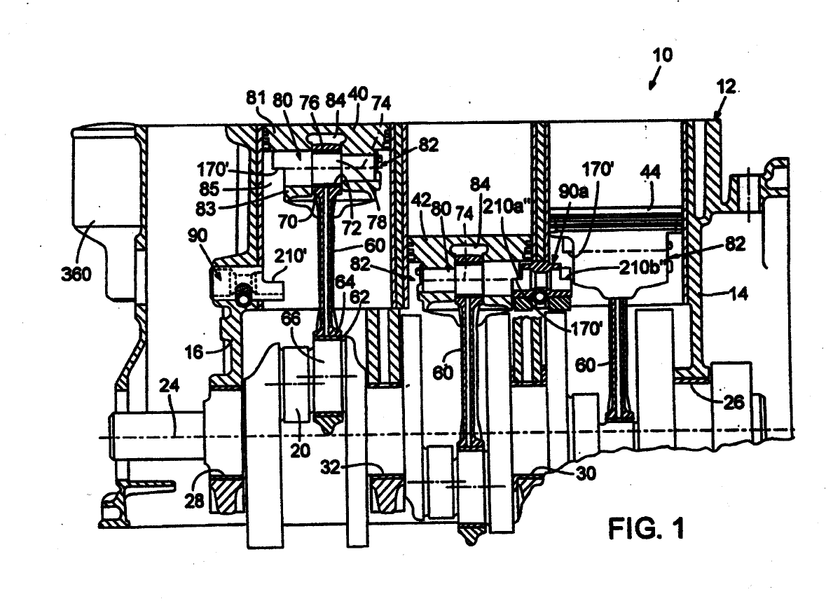

FIG. 1 illustrates a vertical sectional view through a portion of an internal combustion engine, in this case a six cylinder engine. Various dimensions of an exemplary engine are set forth in Table 1 below. It is to be understood that these dimensions are for example only and do not limit the scope of this disclosure.

TABLE 1
Example

| 6 Zyl | V 90° | | Compression Chamber Volume |
|---|---|---|---|
| | | | 56.8-35.5 cm³ |
| Bore | 94 | mm | Eccentricity Piston Pin E1 = 1.8 mm |
| Stroke | 82 | mm | Piston Pin turning angle max 110° |
| Displacement | 3408 | cm³ | Piston movement max 3 mm |

| | | |
|---|---|---|
| Compression Ratio | 10-16 | Eccentricity Piston centerline/Pin |
| | | centerline E2 = 1.4 mm |

The engine 10 of FIG. 1 comprises a portion of an engine block 12 having respective end walls 14, 16 that pivotally support a crank shaft 20 for rotation about an axis 24. Respective bearings 26, 28 (or bushings) pivotally couple the crank shaft to the respective housing walls. Additional support bearings or bushings 30, 32 couple the crank shaft to the engine housing at locations intermediate the ends of the crank shaft for further support.

For purposes of clarity only, portions of three pistons 40, 42 and 44 are shown in FIG. 1, the other three pistons of this illustrative engine are not shown. The technological developments disclosed herein are not limited to six cylinder engine applications as engines with any number of cylinders can utilize the technology.

In FIG. 1, the piston 40 is shown in a top dead center position, the piston 42 is shown in a bottom dead center position and the piston 44 is shown in an intermediate position. Since each of the pistons and the associated coupling elements can be identical, like numbers are assigned to like components for the various pistons and will be discussed in connection with piston 40. Thus, a piston or connecting rod 60 is coupled by bearings or bushings 62 at a lower end portion 64 of the connecting rod to a connecting rod mounting location 66 of the crank shaft 20. The upper end portion 70 of connecting rod 60 is provided with an opening 72 extending therethrough, the opening having a longitudinal axis 74 that is parallel to the longitudinal axis 24 of the crank shaft. In the example shown in FIG. 1, opening 72 is of a right cylindrical shape. A piston coupling bushing or bearing 76 can be positioned within opening 72. Bushing 76 has a centrally extending coupler receiving opening 78 extending therethrough. Opening 78 is of a right cylindrical configuration in this example and has a longitudinal axis concentric with the axis 74. A coupler such as a coupling or piston pin 80 extends through the opening 78 and couples the piston 40 to the connecting rod 60.

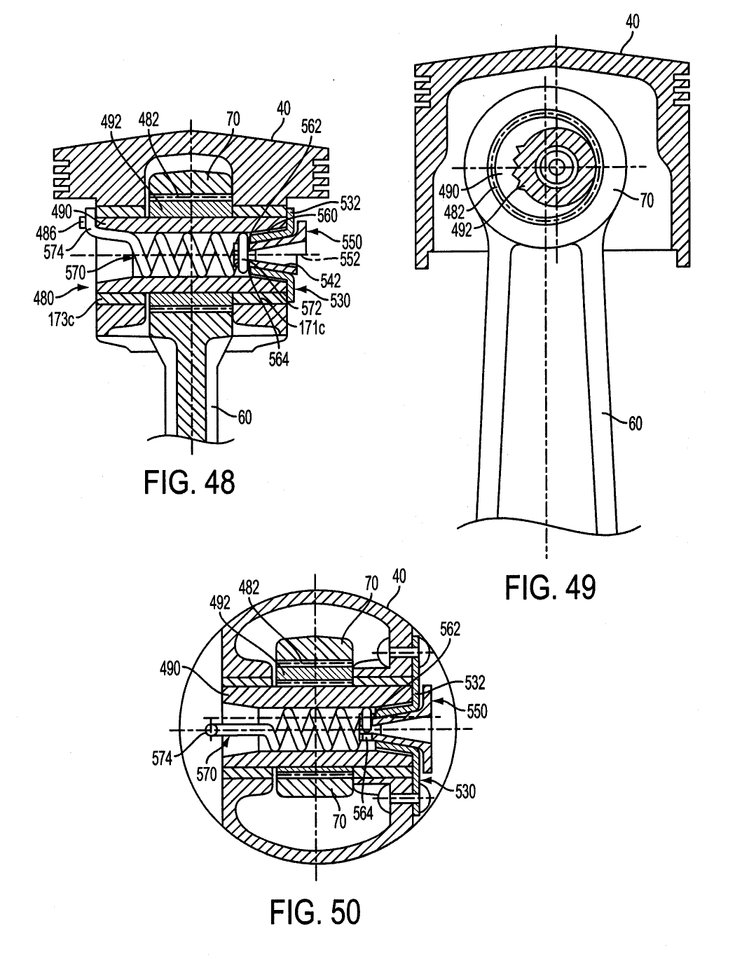

The piston 40 comprises a body having an upper cylindrical piston ring supporting portion 81 of a first diameter and a lower body portion sized to create a pivot member engager or compression ratio adjuster receiving space between the lower body portion 83. One end portion of the piston pin 40 extends outwardly from the lower body portion 83 and into a pivot member engager receiving space 85, said one end portion of the piston pin can comprise a pivot member engager (e.g., including engagement surface 170′) as explained below. In embodiments described in connection with FIGS. 48 and 69 below, the end portion of the piston is shown not extending outwardly. In those alternate embodiments, a compression ratio adjuster (described below) extends into this space. One or more pivot member engagement surfaces can be included in this compression ratio adjuster in the same manner as the pivot member engagement surfaces of the pivot member engager of the FIG. 1 embodiment.

Thus, in one embodiment, a pivot member engager comprises an outwardly projecting portion of a pivot coupler.

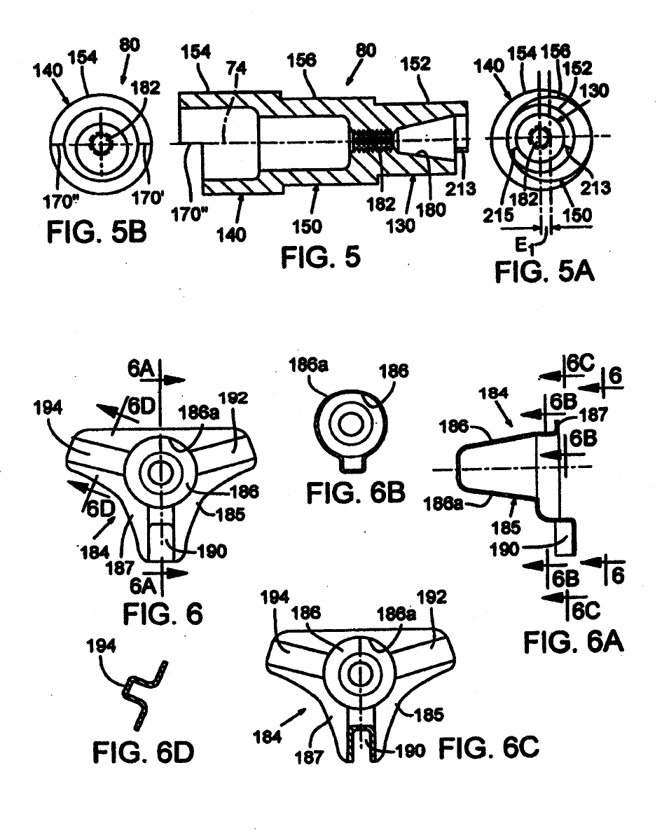

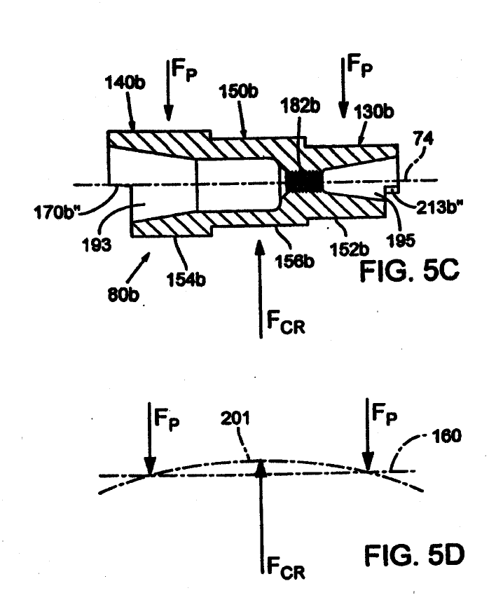

Coupler 80 in this configuration comprises an eccentric that can be pivoted to cause relative motion of the piston 40 relative to the connecting rod 60 to thereby vary the combustion chamber volume and thereby the compression ratio of the cylinder. Suitable couplers can assume shapes other than the shape of an elongated pin and comprise an eccentric operable to selectively shift the pivot axis of the connecting rod where it is coupled to the piston relative to the pivot axis about which the piston and pivot pin pivots. Exemplary constructions of an eccentric coupler 80 in the form of piston pins are described below. A coupler retaining mechanism, for example a friction brake 82, an example of which is explained below, can be used to retain the coupler 80 in, or resist the motion of the coupler 88 from, a desired position to which it has been pivoted. Given the small eccentricity that can be employed in certain embodiments of this technology, the piston coupler, such as the pin, can interfit tightly enough with the piston to resist motion from a desired position to which it has been pivoted until such time as the resistance is overcome by engaging a pivot member that has been shifted to a different position. In the embodiments of FIGS. 48 and 69, the eccentric can be threadedly coupled to the connecting rod. A cavity 84 is provided in the head of piston 40 to accommodate the relative movement of the piston and connecting rod. A pivot mechanism is utilized to pivot the coupler 80 to a desired position of eccentricity to adjust the compression ratio. An exemplary form of pivot member 90 is shown in FIG. 1 and is described in more detail below. This same pivot mechanism can be used in connection with the embodiments of FIGS. 48 and 69 and for this reason is not discussed again in connection with such embodiments. However, in such examples the pivot coupler engagement surfaces comprise compression ratio adjuster engagement surfaces. A modified form of pivot member 90a is shown for selective coupling to the couplers for pistons 42 and 44 and is also described below. The pivot member 90a is an example of, a single or common pivot member for engaging the piston couplers 80 associated with first and second pistons (e.g., pistons 42,44), the pivot member 90a comprising a first set of two pivot coupler engagement surfaces (e.g., 210a′, 210a″ of FIG. 9) for engaging the two pivot member engagement surfaces (e.g., 170′,170″ of FIG. 5B) of the piston coupler 80 associated with the piston 42 and a second set of two pivot coupler engagement surfaces (e.g., 210b′, 210b″ of FIG. 9) for engaging the two pivot member engagement surfaces (e.g., 170′,170″) of the piston coupler 80 associated with the piston 44.

Thus, in this example, there is at least one pivot member operable to pivot the pivot coupler of more than one piston.

In general, in the illustrated embodiment, as a piston approaches the bottom dead center position, the piston coupler 80 (or compression ratio adjusters in the FIGS. 48 and 69 embodiments) engages the pivot member 90 and, if the pivot member 90 has been pivoted to adjust the eccentricity of the associated coupler, the coupler engages the pivot member and is pivoted to the desired eccentricity position. During pivoting of coupler 80, the friction applied by friction brake 82, if included, is overcome to allow such pivoting. Following pivoting, the friction brake 82 retains the coupler 80 in position relative the connecting rod 60 until further adjustment of the pivot member to adjust the eccentricity position. If during a stroke the coupler 80 happens to pivot slightly in an undesired manner, upon return to the bottom dead center position, the coupler 80 is again adjusted to the desired position of eccentricity by engagement of the pivot engager portion of the coupler with the pivot member 90. The pivot members 90, 90a can be pivoted together so that their positions are maintained at the same rotational position. As each cylinder reaches its bottom dead center position, the eccentricity of the cylinder is adjusted if the pivot member has been turned. For example, in FIG. 1, piston 42 is at the bottom dead center position with surface 170″ of piston coupler 80 shown engaging a surface 210a″ of pivot member 90a. If pivot member 90a has been turned to adjust the eccentricity of the associated coupler 80, upon such engagement of surfaces 210a″ and 170″, the coupler 80 for piston 42 turns to adjust the relative position of piston 42 to its associated connecting rod 60. Similarly, as each of the other pistons 40,44 reach their bottom dead center positions, they would likewise be adjusted to the desired compression ratio by pivoting their associated couplers 80 (or in response to pivoting of the compression ratio adjusters as explained below in connection with the FIGS. 48 and 69 embodiments.

Thus, an exemplary internal combustion engine comprises a rotatable crank shaft 24; at least one piston cylinder (e.g., in one example, six cylinders including cylinders receiving pistons 40,42 and 44) with each piston being slidably received by its associated cylinder so as to reciprocate between top dead center and bottom dead center positions within the receiving cylinder. The piston comprises a first piston coupler portion receiving bore defining a first axis (e.g., axis 74 explained below) (see e.g., FIG. 7). The connecting rod 60 comprises a first crank coupling end portion 64 pivotally coupled to the crank shaft such that rotation of the crank shaft causes the connecting rod to reciprocate. The connecting rod 60 also comprises a second piston coupling end portion 70 comprising a second piston coupler receiving bore defining a second axis 160. A piston coupler (e.g., a piston pin 80) comprises a piston coupler portion pivotally received by the piston coupler receiving bore (e.g., the ends of piston pin 80 can comprise the piston coupler portion) so as to be pivotable about the first axis. The piston coupler comprises a connecting rod coupler portion (e.g. 78) pivotally received by the second piston coupler receiving bore to couple the connecting rod 60 to the piston (e.g., 40). One of the piston coupler portion and connecting rod coupler portion comprises an eccentric portion such that reciprocation of the connecting rod causes the piston to reciprocate between the top dead center and bottom dead center positions. Also, pivoting of the piston coupler about the first axis from a first coupler position to a second coupler position pivots the eccentric portion from a first eccentric position to a second eccentric position and shifts the second axis relative to the first axis to thereby vary the compression ratio of the associated cylinder. For purposes of an example, the portion 78 of pin 80C can be considered an eccentric portion. Alternatively, the piston coupler portion can be the eccentric portion. The piston coupler also comprises a pivot member engager that can comprise an end portion of a piston pin (e.g., surfaces 170′, 170″) and a pivot member (e.g., 90, 90a) comprising a pivot coupler engager (e.g., surfaces 210′, 210″; 210a′, 210a″; 210b′, 210b″) movable from a first pivot coupler engager position to a second pivot coupler engager position and positioned to engage the pivot member engager to pivot the piston coupler from the first coupler position to the second coupler position as the piston approaches the bottom dead center position and in response to such movement of the pivot coupler engager from the first pivot coupler engager position to the second pivot coupler engager position. The pivot coupler engager is also operable in one embodiment to disengage the pivot member engager as the piston travels away from the bottom dead center position.

The pivot member can be pivotable about a pivot member axis. In such a case, the pivot member can be pivotable about the pivot member axis from a first pivot member position to a second pivot member position to pivot the pivot coupler engager from the first pivot couple engager position to the second pivot coupler engager position. The piston coupler is pivoted from a first coupler position to a second coupler position as the piston approaches the bottom dead center position in response to the pivoting of the pivot coupler engager from the first pivot coupler engager position to the second pivot coupler engager position.

The pivot member engager can comprise at least one pivot member engagement surface (e.g., surface 170′) and the pivot coupler engager can comprise at least one pivot coupler engagement surface (e.g. surface 210′). In this example, the at least one pivot coupler engagement surface can be pivoted from a first position to a second position in response to pivoting of the pivot member from the first pivot member position to the second pivot member position. The at least one pivot member engagement surface and at least one pivot coupler engagement surface are desirably positioned to engage one another as the piston approaches the bottom dead center position to pivot the piston coupler from the first coupler position to the second coupler position in response to the pivoting of the at least one pivot coupler engagement surface from the pivot coupler engager first position to the pivot coupler engager second position. The at least one pivot coupler engagement surface and the at least one pivot member engagement surface can each be a flat surface and such surfaces can be planar. In a specific embodiment, there are two of said pivot member engagement surfaces (e.g., 170′, 170″) positioned on opposite sides of the first axis. In an alternative embodiment, there can be a first set of two pivot coupler engagement surfaces on opposite sides of the pivot member axis (see surfaces 210′, 210″ of pivot member 90 and either surfaces 210a′, 210a″ or 210b′, 210b″ of pivot member 90a). In a specific form, the pivot member engager comprises downwardly facing first and second pivot member engagement surfaces of one end portion of a piston pin.

In the example of FIG. 1, the couplers 80 can, for example, have an eccentricity of 1.8 mm. In addition, the turning angle of the pivot member 90, 90a can be limited to a predetermined amount or extent. In a specific example, the turning angle can be limited to 110 degrees to thereby provide a maximum 3 mm piston movement. With the exemplary dimensions shown in Table 1, a variable combustion chamber volume is provided and a variable compression ratio of from 10-16 results. These dimensions can be varied.

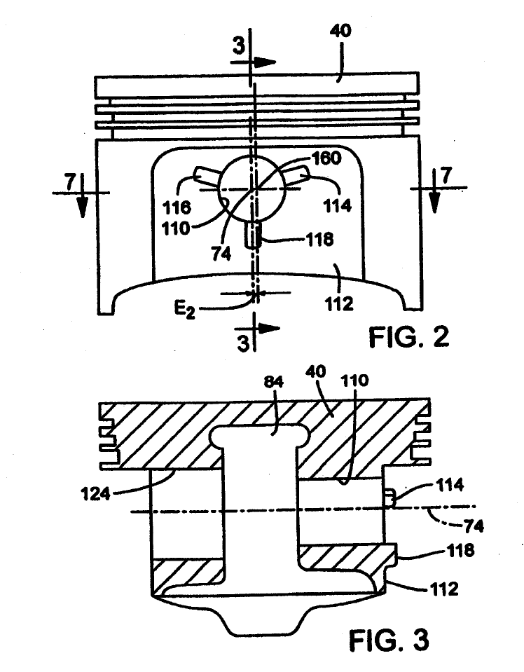

FIG. 2 illustrates the piston 40 without the coupler 80 and without the connecting rod 60 coupled thereto. The piston 40 comprises a first bore section 110 of circular cross-section and having a longitudinal axis aligned with the longitudinal axis 74 in this example. Friction brake engagers are provided adjacent to the bore 110. These engagers can take numerous forms and are designed to engage a friction brake in the illustrated example to prevent rotation of the friction brake relative to the piston. Although recesses and other interfitting arrangements can be used, in FIG. 2 a plurality of projections, in this case radially extending projections 114,116 and 118 are provided. These projections extend in an outward direction from the edge of bore 110 at locations spaced 120 degrees about the center of the bore 110. These projections extend outwardly away from a surface 112 of the piston.

In FIG. 3, a vertical sectional view through piston 40 of FIG. 2, the bore 110 is shown along with the projections 114 and 118. A second bore 124, having a longitudinal axis corresponding to the axis 74 in this example, is also shown. The bores 110 and 124 are co-axial and are of right cylindrical shape.

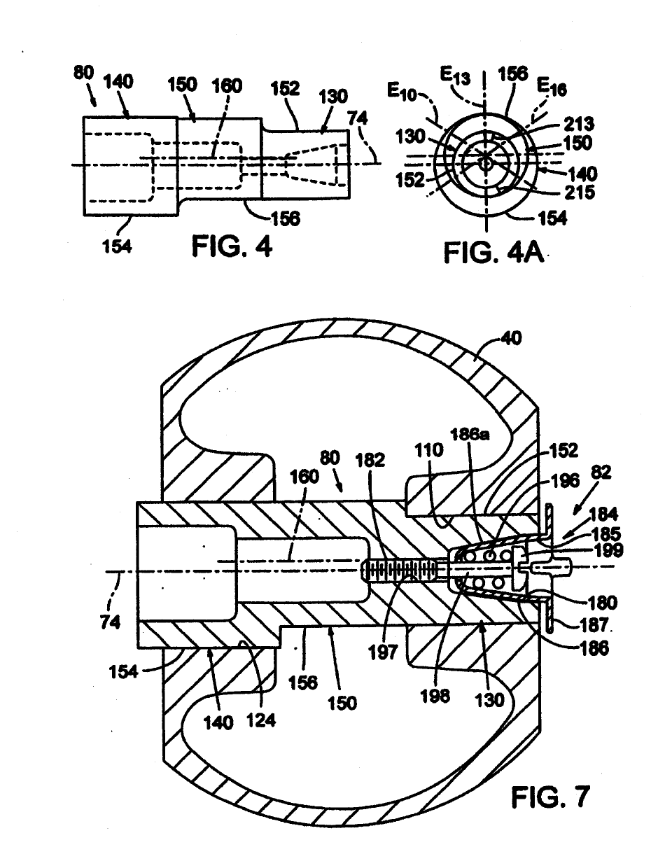

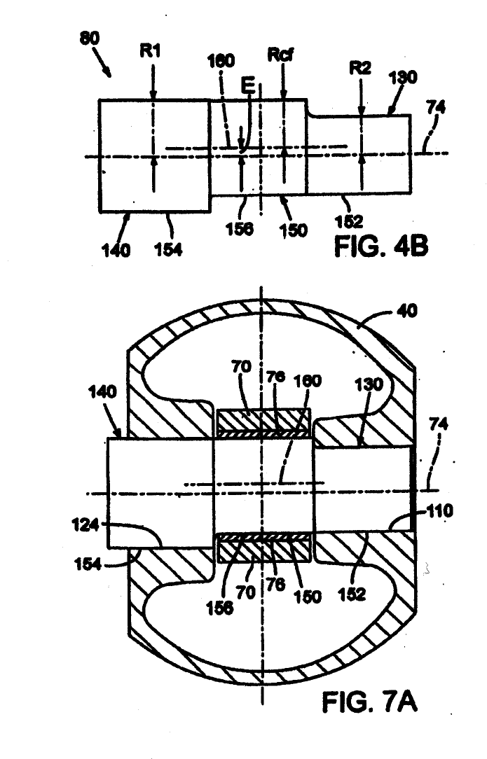

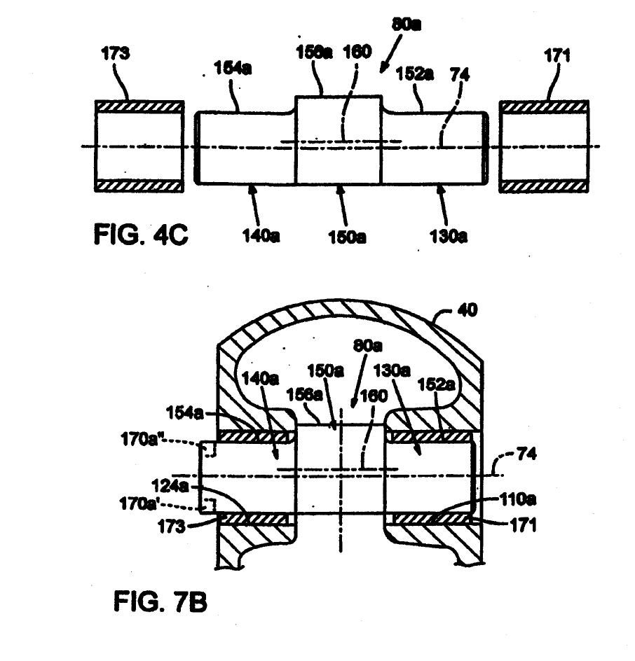

FIGS. 4, 4B, 5, 5A and 5B illustrate an exemplary eccentric piston coupler 80 in the form of a piston pin for coupling the piston 40 to the associated connecting rod 60. Coupler 80 comprises a first end portion 130, a second end portion 140 and a central section 150 intermediate the first and second end portions 130,140. End portion 130 comprises an exterior right cylindrical surface 152. End section 140 comprises a right cylindrical surface 154. In addition, the central portion 150 comprises a right cylindrical surface 156. The axis of cylindrical surface 156 is centered on the axis 160. In contrast, the surfaces 152,154 are eccentrically located relative to axis 160 as these surfaces have a longitudinal axis centered on an axis 74 with the spacing between axes 74 and 160 indicating the eccentric offset (see, e.g., offset E₂ in FIG. 2). FIG. 4a illustrates an end view of the coupler 80 of FIG. 4. Thus, at least one portion of the piston coupler of this example can comprise an eccentric portion that is eccentric relative to at least one other portion of the piston coupler.

With reference to FIG. 4B, the maximum eccentricity of this form of coupler can be defined as E and corresponds to the maximum offset between the first and second axes 74,160 arising from pivoting the eccentric portion 150. The piston coupler 80 comprises a piston pin comprising first and third portions 130,140 and a second portion 150 intermediate the first and third portions, the first and third portions have longitudinal centerlines that are aligned with the first axis 160. In addition, the second portion 150 comprises the eccentric portion and has a longitudinal center line that is aligned with the second axis 160. In this example, the first, second and third portions comprise right cylindrical surfaces 152,154. Also, the second portion comprises a right cylindrical surface 156 of a first radius defined as R_{CR}, one of the first and third portions (e.g., portion 140) has a right cylindrical surface of a radius R₁, wherein R₁≧(R_{CR}+E), and the other of the first and third portions (e.g., portion 130) has a right cylindrical surface of a radius R₂, wherein R₂≦(R_{CR}−E).

In an embodiment shown in FIG. 5C, a second end portion 140b of the piston pin defines a second cavity 193 that is at least partially conical. In this example, a pivot member engager comprises (e.g., including surface 170b″) an outwardly projecting portion of the second end portion of the piston pin. Also, a first end portion 130b of this form of pivot pin also defines a first cavity 195 that is at least partially conical with a surface 213b″ operable as explained below in connection with surface 213 of FIG. 7.

An internal cavity 182b interconnects the first and second cavities 193,195. The internal cavity and the first and second cavities can be shaped and dimensioned to achieve a homogenous bending line 201 (FIG. 5D) in response to the application of force by the piston to the piston pin (forces Fₚ, Fₚ applied to end portions of the piston pin) and the counterforce applied by the connecting rod during operation of the engine.

The piston coupler can comprise a first end portion 130 (FIG. 7) comprising a piston coupler braking surface and a second end portion 140, the pivot member engager can comprise an outwardly projecting portion of the second end portion. FIG. 7 illustrates the coupler 80 installed in place. With this exemplary construction, turning of the coupler 80 shifts the piston relative to the piston rod to thereby vary the compression ratio.

FIGS. 4C and 7B illustrate an alternative form of coupler 80a. In this form, first and third portions 130a, 140a have respective first and third diameters that are equal. Also, portion 150a has a second diameter that is greater than the first and third diameters. In this example, the piston coupler receiving bore comprises right cylindrical first and second piston bore portions 110a, 124a having a diameter that is greater than the second diameter such that the piston pin is insertable in one direction through one of the first and second piston bore portions and the connecting rod bore. A first bushing 171 is mounted to the first piston pin portion 130a and positioned within the first piston bore portion 110a and second bushing 173 is mounted to the third piston pin portion 140a and is positioned within the second piston bore portion 124a. One or both of the bushings 171, 173 are desirably mounted in place after the piston pin has been inserted into the piston and through the connecting rod. The first and second bushings 171, 173 restrict the piston pin against motion along the axis 74.

With reference to FIG. 5B, an exemplary pivot member engager can comprise at least one pivot member engagement surface (e.g., two surfaces 170′ and 170″). The pivot coupler engager can comprise at least one pivot coupler engagement surface (see FIG. 9). The at least one pivot coupler engagement surface can be pivoted from a first position to a second position in response to pivoting of the pivot member from the first pivot member position to the second pivot member position. The at least one pivot member engagement surface and at least one pivot coupler engagement surface are desirably positioned to engage one another as the piston approaches the bottom dead center position to pivot the piston coupler from the first coupler position to the second coupler position in response to the pivoting of the at least one pivot coupler engagement surface from the pivot coupler engager first position to the pivot coupler engager second position.

Again, FIG. 5 illustrates a vertical sectional view through the exemplary coupler 80. FIGS. 5a and 5b are respective end views of the coupler. FIG. 5 also illustrates a pivot member engaging element, in this case a surface 170″ positioned to engage the pivot member 90 to turn the coupler 80 to adjust the eccentricity of the coupler and thereby the compression ratio as explained below.

The internal combustion engine can also comprise a piston coupler retainer coupled to the piston coupler to apply a retention force to resist pivoting of the piston coupler. The piston coupler retainer can also limit the pivoting of the pivot coupler about the first axis (e.g., axis 74) to be within a predetermined limit. One specific example of a mechanism for retaining the piston coupler in a location to which it has been pivoted or turned, comprises a friction brake. The illustrated coupler comprises a brake engaging surface, such as a partially conical or frustoconical recess 180 extending inwardly into the end portion 130 of coupler 80. An internal bore 182 is provided at the base of recess 180. An exemplary friction brake 184 is shown in FIGS. 6 and 6a. The illustrated friction brake comprises a body 185 with a generally conical braking component 186 having an external braking surface 186a shaped to engage the braking surface 180 of the coupler 80. The body 185 can comprise a generally triangular base portion 187 from which the braking portion 186 projects. The base 185 can also be provided with interfitting members that mate with or interfit with corresponding interfitting members of the piston. Thus, for example, the base can comprise plural indentations or recesses 190,192,194 for engaging the respective projections 118, 114 and 116 of the piston (see FIG. 2). When engaged in this manner, relative rotation between the brake 184 and the piston 42 is prevented. As can be seen in FIG. 7, a biasing spring 196 can be positioned within the conical portion 186 of the break 184. A braking force adjustment screw 198 having a head 197 threadedly received and captured in a threaded bore 182 of coupler 80 is provided. A nut 199 coupled to screw 198 can be rotated to adjust the braking force by changing the axial position of the screw in bore 182 to thereby change the compression of the spring 196. The nut 199 can be fastened to or otherwise mounted so as to be retained on the screw so as not to be dislodged during operation of the engine. Surfaces 213, 215 (FIG. 4A) of the piston pin cooperate with the friction brake to limit the extent of pivoting of the piston pin to within a predetermined angular limit, such as 110 degrees. Other mechanisms can be used to limit such pivoting.

Thus, in this example, each of the piston coupler braking surface and friction brake braking surface is at least partially conical. The piston coupler, in this example, comprises a piston pin with first and second end portions, the first end portion comprising a brake receiving first cavity defining the piston coupler braking surface. Also, a friction brake being inserted at least partially into the brake receiving cavity in this example.

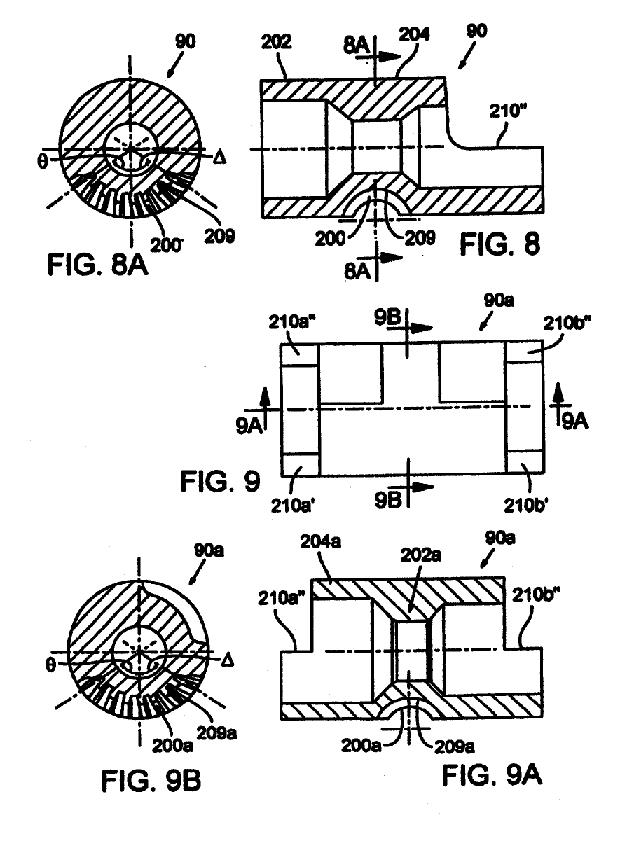

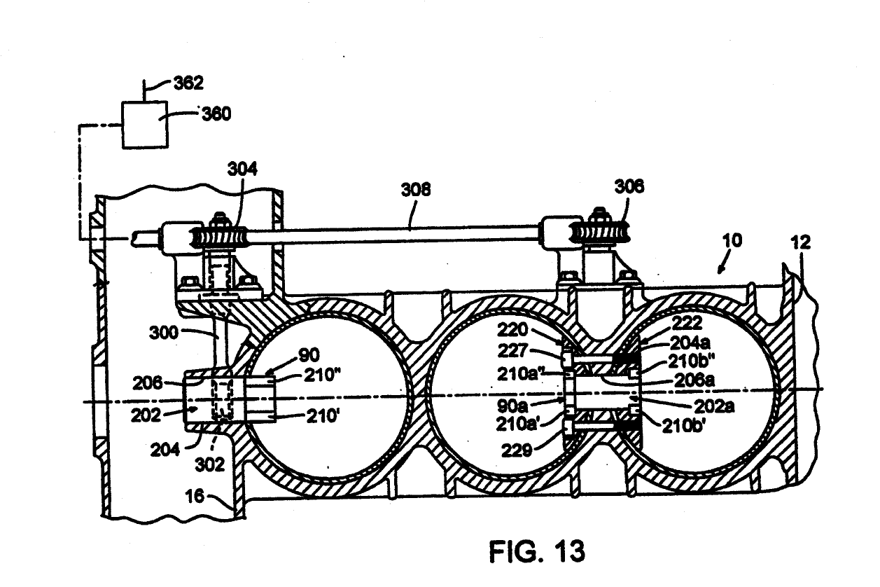

FIGS. 8 and 8a illustrate an exemplary pivot member 90. The illustrated pivot member comprises a body 202 having an outer surface 204 which can be of a right cylindrical shape for insertion into a bore 206 in the end wall 16 of the engine housing 12 (FIG. 13). A recess 209 can be provided in the body 202. In the FIGS. 8 and 8a form, recess 209 is an arcuate recess having a radius and centered about the axis 24. A worm gear 200 is positioned and captured or formed within recess 209. As can be seen in FIG. 8a, the illustrated recess 209 does not extend entirely around the circumference of the body 202. Instead, the recess 209 and worm gear is of a limited length, in this example, although this can be varied, the length is limited to “θ”+“Δ”, such as 110 degrees (e.g., in the example where “θ” is equal to “Δ” and equal to 55 degrees, 55 degrees either side of vertical). This limits the extent to which the pivot member 90 can be turned during operation of the engine. The pivot member also comprises first and second eccentric coupler engaging surfaces 210′, 210″ (only one, namely 210″, of which is shown in FIG. 8, and with both of these surfaces being shown in FIG. 13). The operation of these surfaces to engage and pivot the eccentric coupler will be understood from the description below.

In this example, the worm gear drivenly is coupled to the pivot member. A motor can be coupled to the worm gear and is operable to pivot the pivot member from plural first positions to plural second positions to adjust the compression ratio to a plurality of values. Also, as a specific example, the pivot member can define a recess extending in a direction perpendicular to the pivot member axis, the worm gear being positioned at least partially in the recess. The worm gear engages the pivot member to restrict movement of the pivot member in either direction along the pivot member axis. Also, as explained above, the worm gear can be configured to restrict pivoting of the pivot member to be within a predetermined limit. Thus, the predetermined limit can be, in one example, approximately one hundred and ten degrees. The center position of the limit can correspond to the pivot coupler being pivoted to a position that aligns the first axis 74 and the second axis 160.

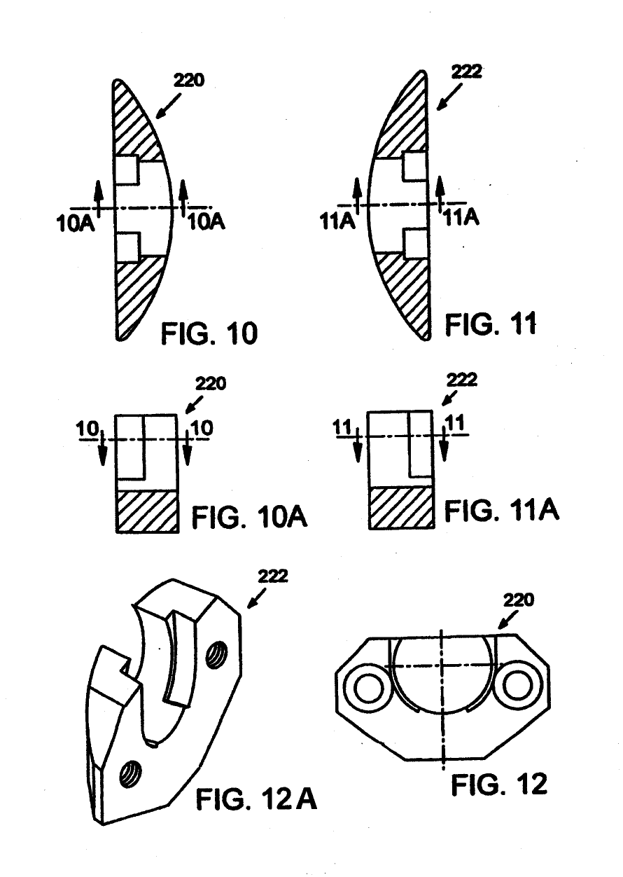

FIGS. 9, 9A and 9B illustrate another exemplary form of pivot member 90a. Components of the FIG. 9A example of pivot member in common with those of pivot member 90 are assigned the same numbers as in FIGS. 8 and 8A with the letter “a” following the number. When mounted in place, the illustrated form of pivot member 90a provides two coupler engaging surfaces 210a′, 210a″ in position to engage the piston coupler 80 that couples piston 42 to its associated piston rod 60 and two coupler engaging surfaces 210b′ and 210b″ in position to engage the coupler 80 that couples piston 44 to its piston rod 60. These engaging surfaces are also shown in FIG. 13. Pivot member supports 220,222 shown in FIGS. 10, 10A, 11, 11A and 12 can be mounted to engine block 12 as shown in FIG. 13 to support and retain the pivot member 90a in position. In this example, pivot member 90a comprises one form of a common pivot member comprising a first pivot member end portion extending into a first region defined by the first cylinder and a second pivot member end portion extending into a second region defined by the second cylinder. A first bracket can be coupled to the first cylinder in a position to pivotally support the first pivot member end portion. A second bracket can be coupled to the second cylinder in a position to pivotally support the second pivot member end portion. The first and second brackets can be fastened together (e.g., using bolts 227, 229) with a portion of the first cylinder and a portion of the second cylinder positioned between the first and second brackets. The first and second bracket can be shaped to provide clearance for the respective pivot member engagement surfaces and pivot coupler engagement surface to engage one another.

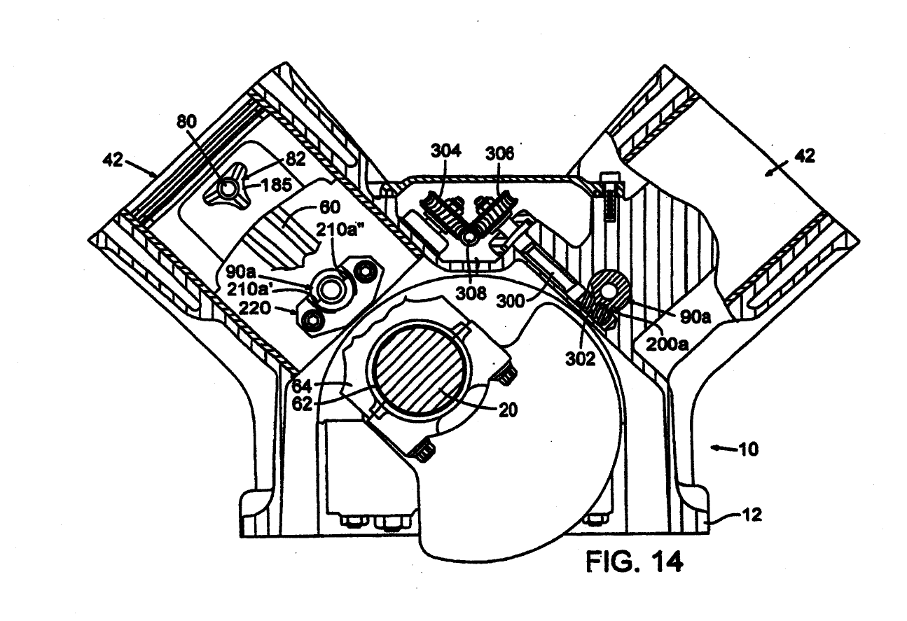

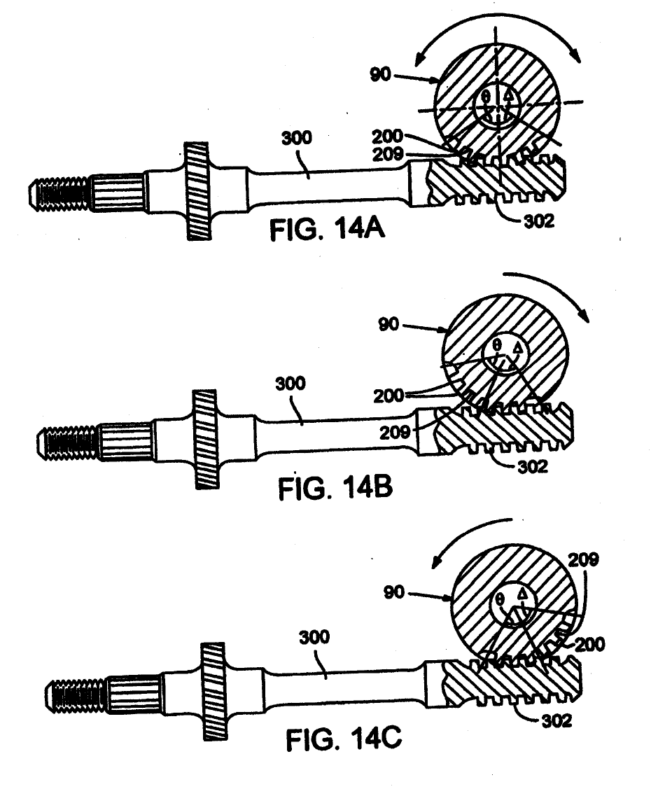

With reference to FIG. 13, a shaft 300 having a distal end portion with a worm gear drive portion 302 engages the worm gear 200 of pivot member 90 such that rotation of the shaft 300 in respective opposite directions pivots the pivot member 90 in respective opposite directions within the limits of the worm gear 200. A similar shaft (not shown) can be used to drive the worm gear 209a of pivot member 90a. These shafts 300 are respectfully driven by worm gears 304,306 coupled thereto. A rotatable shaft 308 having worm gear drive elements coupled thereto and in engagement with worm gears 304,306 is rotated in respective opposite directions to drive the worm gears 304,306 and the associated shafts 300 and pivot members 90 and 90a in the desired direction for adjusting the position of the respective pivot members 90, 90a together. FIGS. 14A, 14B, and 14C illustrate exemplary positions of the pivot member driven by the associated worm gear. A motor 360 controlled by control signals via a connector 362 (or wireless coupling or other coupling) can be controlled to drive the shaft 308 and thereby the mechanism as explained above. Motor 360 can be any suitable motor, such as a stepper motor. Control signals for motor 360 can come from, for example, a microprocessor or electronic control module via an electrical signal carrying bus of a vehicle. The interaction of these components will be more apparent from FIG. 14 wherein corresponding elements are given corresponding numbers.

The operation of these exemplary components will also be better understood with reference to FIGS. 15A-15D.

In FIG. 15A, assume that coupler 90 has been turned counterclockwise (in this example, in the direction of arrow 370) a certain amount to adjust the compression ratio. The amount of turning has been exaggerated in these figures for purposes of illustration. As the piston coupler 80 moves downwardly, as indicated by arrow 350, eventually (as shown in FIG. 15B), a portion of one of the coupler surfaces, in this example surface 170″ engages a portion of one of the pivot member turning surfaces, in this example surface 210″. Continued downward movement of the piston results in rotation (pivoting) of the coupler (in this example in the direction of arrow 372). When in the bottom dead center position shown in FIG. 15C, the surfaces 170′, 170″ of the coupler have been rotated to a position that matches the position of the surfaces 210′, 210″ of the pivot member 90. As the piston moves upwardly, as indicated by arrow 352, and away from the bottom dead center position, the coupler 80 has been adjusted to vary the compression rate (note the position of surfaces 170′, 170″) and can be retained in adjustment by the friction brake as previously explained.

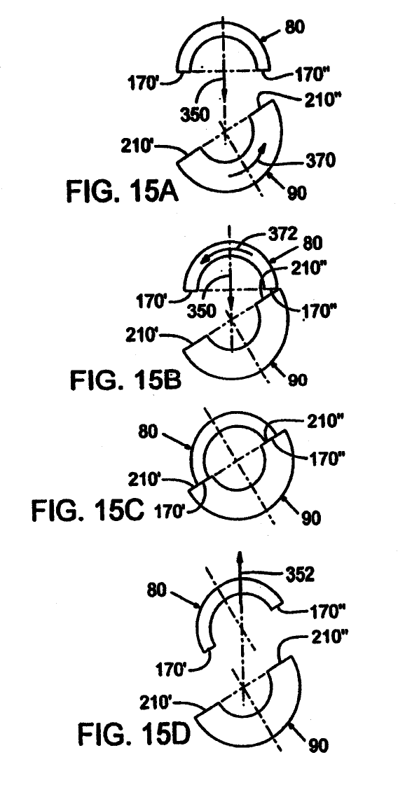

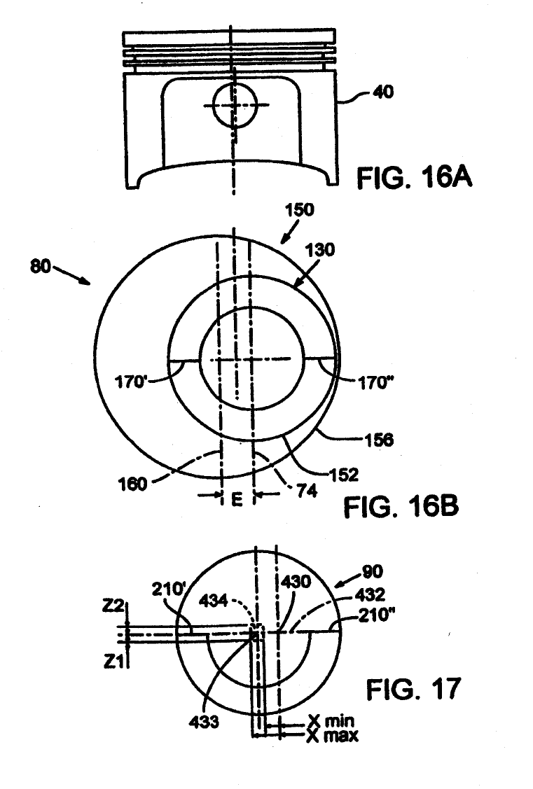

With reference to FIGS. 16A and 16B, a piston cylinder shown with a longitudinal centerline 400. The longitudinal centerline is desirably positioned between a first line parallel to the longitudinal centerline that intersects the first axis and a second line parallel to the longitudinal centerline that intersects the second axis when the eccentric portion is pivoted to the maximum allowed extent.

With reference to FIG. 17, a piston cylinder is illustrated with a longitudinal centerline and wherein the maximum eccentricity is defined as E and corresponds to the maximum offset between the first and second axes, wherein an origin of a reference coordinate system 430 is at the intersection of the longitudinal centerline of the at least one piston cylinder and a bottom dead centerline 432 corresponding the second axis when the second axis is in the bottom dead center position, wherein the Z dimension is along the longitudinal center line of the piston cylinder from the origin and the X dimension is along the bottom dead centerline from the origin, wherein the pivot member axis is parallel to the first axis and, wherein the pivot member axis (into the page and intersecting point 433) intersects an area 434 wherein X is from −0.5E to −0.8E and Z is from −0.25E to 0.25E.

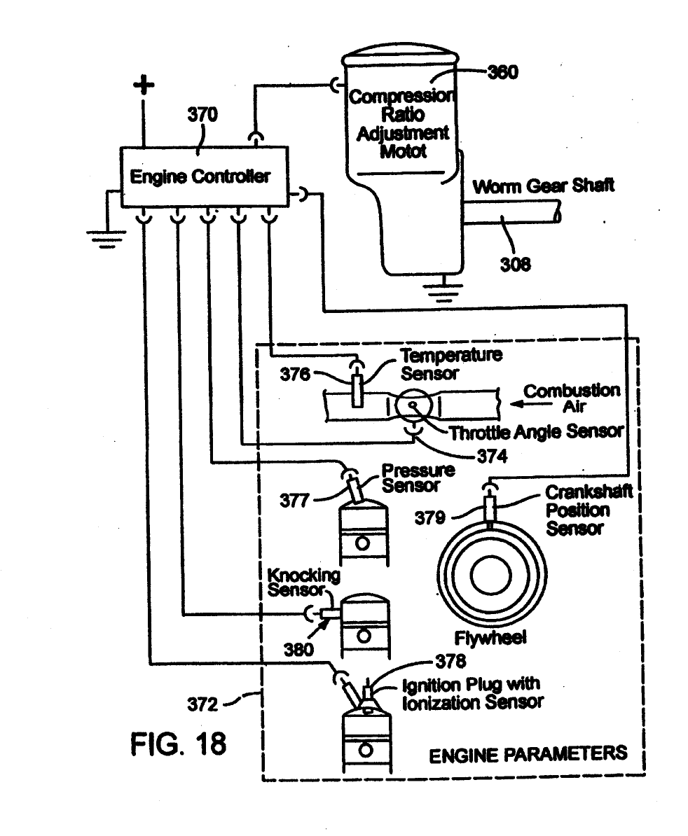

With reference to FIG. 18, an exemplary motor 360 is shown for driving worm gear shaft 308 to pivot the pivot members and adjust the compression ratio of the engine such as previously described. Motor 360 can be a stepper motor or other form of motor and can provide feedback to an engine controller 370 which provides drive signals to the motor. Motor 360 is simply one example of a mechanism for driving a worm gear or other pivot member drive mechanism. Engine controller 370 can be a conventional engine controller, such as programmable controller, used in a vehicle which captures various vehicle parameter signals on a system bus utilized in the vehicle. These parameter signals can be used by the engine controller to generate motor control signals should conditions exist where it is desirable to selectively adjust the pivot members to vary the stroke of the piston cylinders. These control signals can be responsive to one or more engine operating parameters. Exemplary parameters are indicated within block 372, together with schematic illustrations of sensors for measuring the parameters. For example, a throttle angle sensor 374 can be used to deliver a throttle angle signal via a data bus to the engine controller. The motor 360 can drive worm gear 308 in clockwise or counterclockwise directions in response to control signals from the engine controller 370 in response to the throttle angle sensor signals. For example, under open throttle (full load) conditions, the compression ratio would typically be reduced. Under closed throttle (idle) conditions, the compression ratio would typically be increased. As another example, the combustion air temperature can be sensed by temperature sensor 376. In general, higher combustion air temperatures can be used to lower thresholds of alternatively used signals to control the motor to reduce the compression ratio. In contrast, lower temperature sensed signals can be used to increase the threshold to increase the compression ratio. As yet another example, a pressure sensor 377 can be used to sense the cylinder head pressure. Above a pre-defined pressure level at a certain crank shaft position, for example the top dead center position, the compression ratio would typically be decreased. Below this pre-determined pressure level, the compression ratio can be increased. The crank shaft position can be sensed by a crank shaft position sensor 379. As a further example, an ionization sensor, typically integrated into an ignition plug, senses in the moment of ignition the grade of the ionization of the air/fuel mixture of the internal combustion engine. Above a pre-determined threshold, the compression ratio is typically decreased. Below the pre-determined threshold, the compression ratio is typically increased. An ignition plug with an ionization sensor is indicated at 378 in FIG. 18. As another alternative, a knocking sensor indicated schematically at 380, typically mounted to a cylinder block, senses vibration spikes caused by uncontrolled ignition of the combustion mix, corresponding to the engine knocking. In response to such signals, the engine controller 370 can control motor 360 to decrease the compression ratio. Control signals derived from combinations of sensed engine parameter conditions can also be used.

The following portion of the disclosure describes additional embodiments of methods and apparatus for adjusting the compression ratio of an internal combustion engine, such as for gasoline and diesel fueled engines.

To reduce friction losses, it is likely that modern gasoline engines will be reduced in size. However, to keep the output of such engines high, they are likely to be high turbo-charged engines. This may make a compression ratio under high output conditions of, for example, 8 necessary to avoid misfiring. Under low load conditions, a compression ratio of, for example, 14.5, can be desirable to obtain the best efficiency. The span of compression ratios from 8 to 14.5 makes, depending on bore size and stroke, a piston movement of for example, 5.5 mm necessary, which leads to an eccentricity of a piston pin of 3.5 mm in this example.

An example using 3.5 mm eccentricity leads to the following eccentricity torque at the firing point:

Bore 85 mm Surface 8.5×π=56.7 cm²

Firing pressure 140 bar

Force F=56.7×140=7.9 tons or 79,000 Newton meters

$$\begin{matrix}Torque = 79 , 000 Nm \times eccentricity in meters \\ = 79 , 000 \times 0.0035 \\ = 276.5 Newton meters\end{matrix}$$

A torque of 276.5 meters could cause excessive friction that can result in damage to the piston.

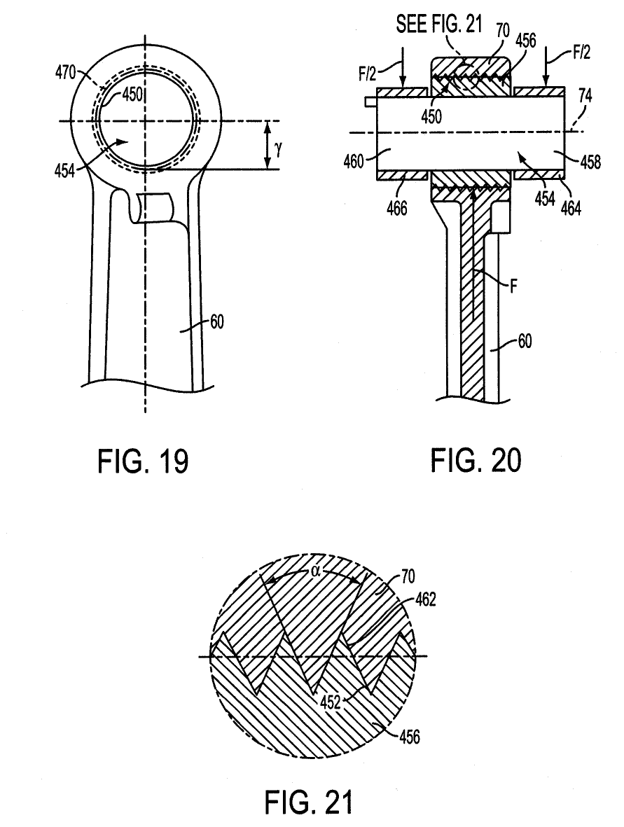

To accommodate these forces, a piston coupler, such as a piston pin 80, can be connected to a connecting rod 60 other than by a pure friction interfit. The connecting rod can easily bear this torque. In one desirable construction, the eccentric portion of the piston pin has a threaded section that is threaded into threads of a piston pin receiving opening of an associated connecting rod 60 to thereby connect the piston pin to the connecting rod. In effect, the threads represent grooves which stabilize the piston pin to prevent it from rotating undesirably as a result of the eccentricity torque as the piston travels between top dead center and bottom dead center piston positions. With this construction, the piston pin swings with the connecting rod. Bearings, such as steel or aluminum bushings pressed into bearing receiving openings in the piston, and which have bearing material on their surfaces, can be used to engage end portions of the piston pin. With reference to FIGS. 19, 20 and 21, a connecting rod 60 is shown with a threaded eccentric receiving central opening indicated at 450 in FIG. 20. The entire opening 450, or a section or portion thereof, can be threaded with one such thread being indicated at 452 in FIG. 21. A pivot coupler such as a piston pin 454 is shown with a central eccentric portion 456 and respective end portions 458 and 460. Piston pin 454 has a center positioned along an axis 74. The eccentric portion 456 is desirably threaded with one such thread being indicated at 462 in FIG. 21. The entire surface of the eccentric portion, or only a portion thereof, may contain the threads. Therefore, the piston pin 454, and in this case the eccentric portion 456, is threadedly received by the connecting rod 60 to thereby connect the connecting rod and piston pin, other than by a pure friction fit. That is, interfitting features, such as threads, couple the connecting rod to the piston pin while permitting relative pivoting of these components. As can be seen in FIG. 20, piston engaging bearings 464, 466 are carried by respective piston pin end portions 458, 460 for engaging the piston.

In FIG. 19 the threaded connection between the connecting rod 60 and piston pin 450 is indicated at 470. In addition, in FIG. 21, an angle between the side walls of the respective threads is shown by the symbol α. In one example, α is 50 degrees. The angle α can be chosen for a particular engine to provide a safety margin that prevents undesirable turning of the piston pin as the piston travels between top dead center and bottom dead center positions while withstanding forces generated by the operating engine (e.g. eccentricity torque and torque caused by friction in bushings/bearings). The grooves or threads, in this example, increase the transmittable torque and thereby can be used to accommodate turbo-charged, but downsized, engines. Consider the following force calculations (which disregard bushing/bearing friction torque).

F=79,000 Newton

$$sine \frac{α}{2} = sine {25}^{°} = 0.4226$$

Friction Coefficient (FC) Steel/Steel oiled=0.1

Angle α=50°

r=radius of eccentricity (see FIG. 19)=17.5 mm or 0.0175 m in this example.

$$Radical force R = \frac{F \times FC}{Sine \frac{α}{2}} = \frac{79 , 000 \times 0.1}{0.4226} = 18.693 N$$

Torque=R×r=18.693N×0.0175 m=327.1 Nm

In the above example, the torque in the thread is computed to be 327.1 Newton meters, which is higher than the maximum eccentricity torque for the exemplary internal combustion engine of 276.5 Newton meters as previously calculated, and also is higher than the sum of the eccentricity torque and other sources of torque arising from engine operation (e.g. the maximum bushing/bearing friction torque). Consequently, this means that the piston pin will not be allowed to pivot in the absence of controlled pivoting by a turning mechanism to adjust the compression ratio. In this specific example, the safety margin is expressed as follows:

$$\begin{matrix}Safety Margin = \frac{327.1}{276.5 + torque from other engine operating torque sources} \\ = 1.18 ( if torque from such other sources is assumed to be zero )\end{matrix}$$

Thus, the safety margin in this example is about twenty percent

$$( \frac{1.18 - 1}{1} ) \times 100 \% = 18 \% .$$

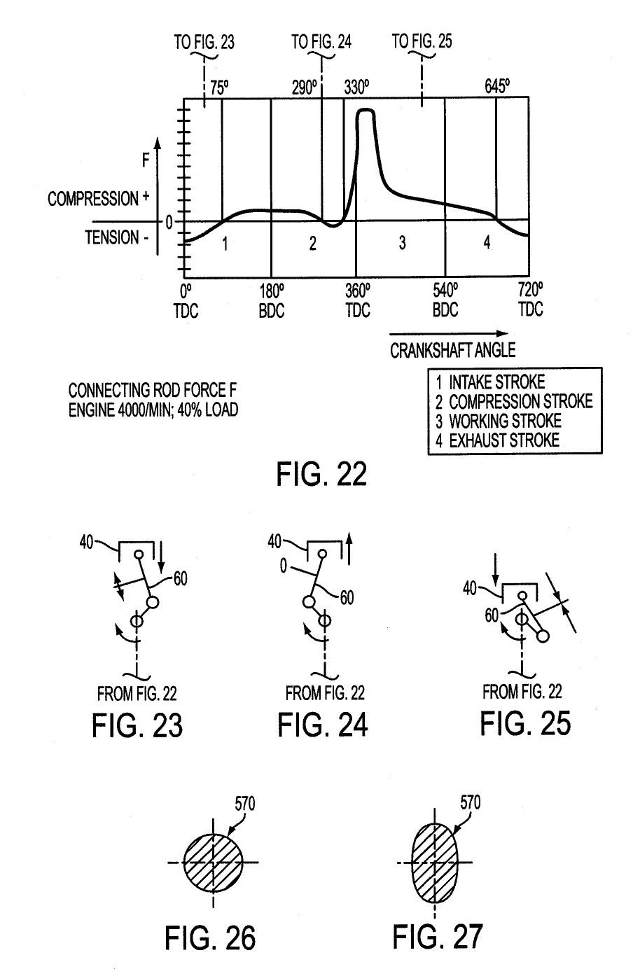

One can also account for torque caused by friction in bushing/bearings in the safety margin, which can be against or in the same direction as the eccentricity torque. Adjustment of the compression ratio by turning the piston pin at a bottom dead center position initiated by engagement of the pivot member with a portion of the pivot pin requires significant force even under low loads. However, during a working cycle of an engine/crankshaft system, the load in a connecting rod changes from compression to tension and from tension back to compression and passes through zero at least twice during the cycle. For example, as can be seen from FIG. 22, in an exemplary engine operating at 4,000 rpm at 40 percent load, the force on the connecting rod passes through zero four times. Specifically at: (a) 75° from top dead center (TDC) during the intake stroke; (b) at 70° and 30° before TDC during the compression stroke, and (c) at 75° before TDC during the exhaust stroke. If adjustments in the positions of the combustion rate adjuster are made at or about the bottom dead center (BDC) position in this example, the loaded biasing member will then adjust the eccentric position as the 70° before TDC position in the compression stroke is approached (if the compression ratio adjustment was made at the BDC position at the start of the compression stroke) and as the 75° before TDC position is approached in the exhaust stroke (if a compression ratio adjustment was made at the BDC position at the start of the exhaust stroke). Under the influence of gas pressure following ignition, compression of the connecting rod occurs. This is also true during acceleration of the piston following the bottom dead center position. Before the top dead center position is reached, the force in the connecting rod changes to tension. This is also the case with the intake stroke, following the top dead center position, during the intake of combustion air.

The force in the connection rod, at least twice during a working cycle of an engine, passes through a point where it is zero. In the region of the working cycle at the point where the force in the connecting rod passes through zero, the torque required to turn the piston pin is low. FIGS. 22, 23, 24 and 25 illustrate the changes in forces on the connecting rod during a working cycle (the exhaust stroke not being separately depicted in these figures). In accordance with a desirable embodiment, the piston pin is turned to thereby adjust the compression ratio at or near one of the low load cycle positions of the connecting rod following the BDC position where the compression ratio adjuster is pivoted in this example.

In one illustrated embodiment, as the piston approaches the bottom dead center position, the pivot member or turning member, when engaged to vary the compression ratio, rotates a compression ratio adjuster relative to an adjuster retainer. This adjuster retainer can be coupled to or connected to the piston such as fixedly mounted to the piston. The compression ratio adjuster can alternatively be coupled to the connecting rod and to the piston. A biasing member, such as a spring coupled to the piston pin and to the compression ratio adjuster defines the friction torque or pressure. The compression ratio adjuster is pivoted by the pivot member through a selected angle and preloads (e.g. applies a rotational load to the spring, resulting in torsional energy being stored in the spring) the biasing member. The biasing member rotates the piston pin when the torque requirements for rotating the piston pin are low, such as before the top dead center position is reached by the piston and after the piston has left the bottom dead center position (or after the top dead center position if a compression ratio adjustment is made at other than the bottom dead center position, e.g., at or near the top dead center position). A spring biasing member in one embodiment has two primary functions. First, the spring applies tension to create the friction (an axial force) between an adjuster retainer and compression ratio adjuster. Secondly, the spring provides the rotational force to rotate the piston pin as desired when the load on the connecting rod is reduced. The cross-section of the spring can be selected to provide a desired relation between axial force and rotational forces. Alternatively, separate springs can be used, as well as alternative mechanisms, for applying the respective axial and rotational forces. FIGS. 26 and 27 illustrate exemplary spring cross-sections (oval and elliptical).

The operation of the pivot member and its construction can be identical to that of pivot members described elsewhere in this description. However, the coupler engagement surfaces become compression ratio adjuster or adjuster engagement surfaces in these examples.

Rotational adjustment of a piston coupler or piston pin position to vary the compression ratio during the zero/low loading conditions on the connecting rod is a desirable advantage of these latter embodiments.

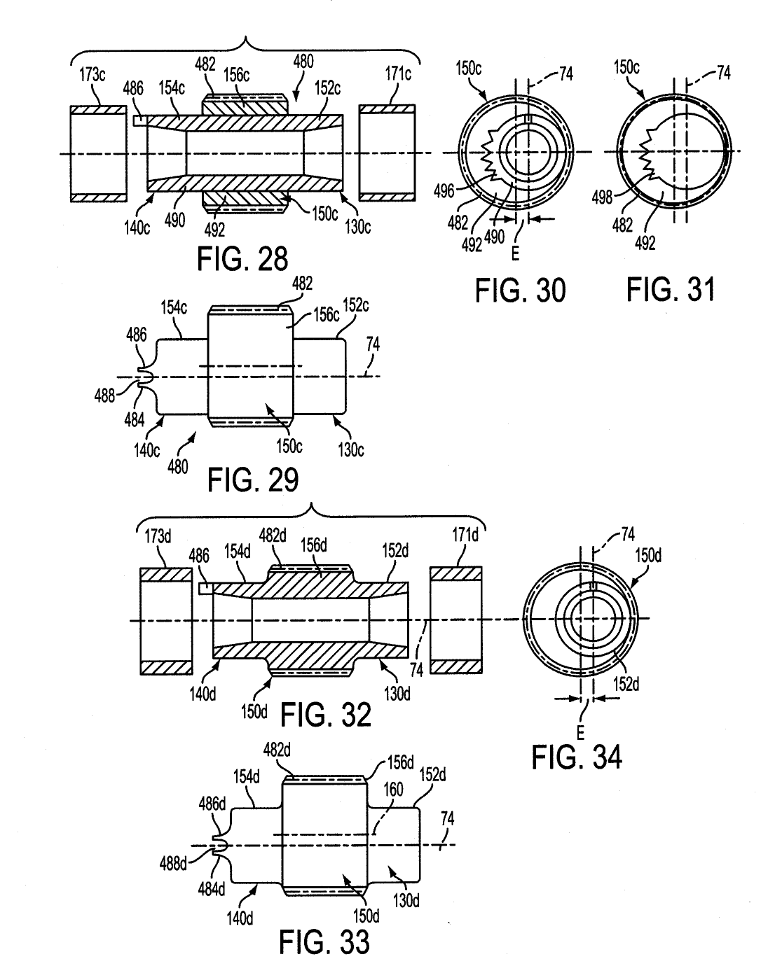

FIGS. 28 through 31 illustrate an exemplary piston coupler, such as a piston pin 480 usable in this alternative embodiment. The piston pin 480 is similar to the piston pin 80a shown in FIG. 4C. Consequently, components of coupler 480 in common with those shown in FIG. 4C have been assigned the same numbers in FIGS. 28-31 as in FIG. 4C, with the letter “c” being added after such components in FIGS. 28-31. Consequently, these common components will not be described in detail. In FIGS. 28 and 29, threads 482 are illustrated at the exterior periphery 156c of the eccentric portion 492 of piston pin 480. These threads can be as described above in connection with FIGS. 20 and 21. In addition, as best seen in FIG. 29, end portion 140c of piston pin 480 comprises first and second projections 484, 486 that define a slot 488 therebetween for receiving and retaining one end of a spring that applies the rotational and friction forces to the piston pin 480. Other alternative forms of a spring retainer can be used (e.g., fasteners).

In addition, in the embodiment of FIGS. 28 and 29, the piston pin 480 comprises a central sleeve portion 490 having a separate eccentric portion 492 mounted thereto. As can be seen in FIG. 30, sleeve portion 490 can comprise inter-fitting features that mate with corresponding features of eccentric portion 492. For example, portion 490 can comprise a plurality of projecting teeth, one of which is indicated at 496 in FIG. 30. Correspondingly, eccentric portion 492 (see FIG. 31) can comprise mating recesses for receiving the teeth, one such recess being indicated at 498 in FIG. 31.

FIGS. 32 through 34 illustrate an alternative form of piston coupler, such as a piston pin 500. Piston pin 500 is like the piston pin 480 except that the eccentric portion of piston pin 500 is of a monolithic unitary one-piece construction, rather than comprising a plurality of components 490, 492. Consequently, elements of the embodiment of FIGS. 32 through 34 that are in common with the elements of the embodiment of FIGS. 28 and 29 have been assigned the same number except with the letter “d” following the numbers. Consequently, these components will not be discussed in detail.

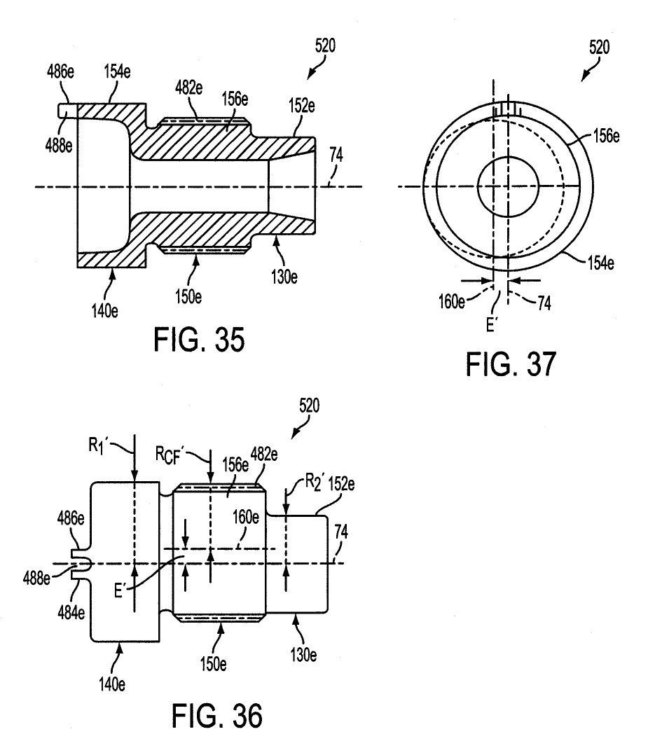

Another embodiment of a piston coupler comprises a piston pin 520 shown in FIGS. 35, 36 and 37. Piston pin 520 is similar to the piston pin 80 of FIG. 4B. Consequently, components corresponding to those shown in FIG. 4B have been given the same number as in FIG. 4B with the letter “e” following the number. In addition, to differentiate these references from those shown in FIG. 4B, a “″” (prime designation) has been added after R1, RCF, R2 and E in FIG. 36. As in the case of the embodiment shown in FIGS. 28 and 32, the eccentric portion 150e of the embodiment of FIGS. 35 and 36 is provided with external threads 482e about at least a portion of the periphery 156e. In addition, a spring receiving slot 488e is defined in end portion 140e by projecting tabs 484e and 486e with the slot positioned therebetween. FIG. 37 is an end view of piston pin 520 looking from the right side of FIG. 35.

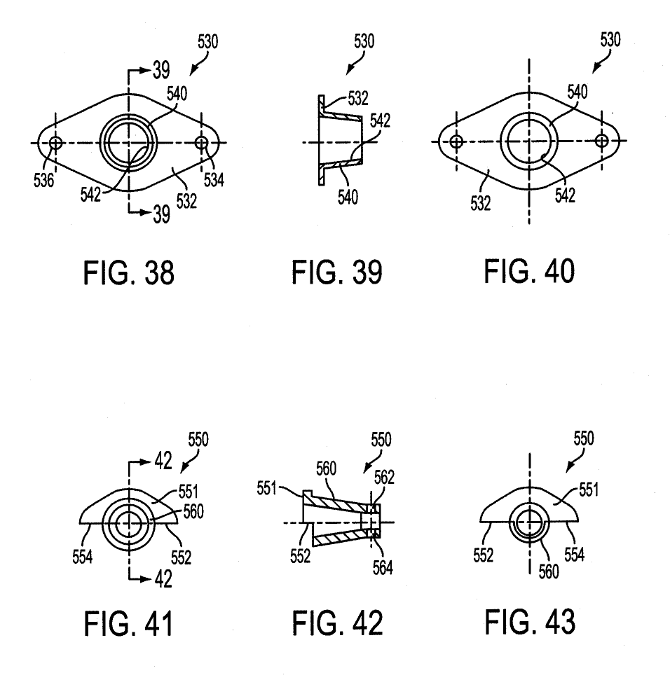

FIGS. 38, 39 and 40 illustrate one form of an adjuster retainer 530, with a friction system, that can be mounted or coupled to a piston for frictional engagement by one form of a pivot member engager, described below as a compression ratio adjuster. The illustrated adjuster retainer 530 in these figures comprises a base 532 with respective fastener receiving openings 534, 536 for use in mounting the base, and thereby the adjuster retainer, to a piston. The associated piston pin desirably has an adjuster retainer receiving recess or cavity for receiving a projecting portion of the adjuster retainer. FIG. 39 is a sectional view of an adjuster retainer 530 taken along lines 39-39 of FIG. 38. The illustrated adjuster retainer comprises an exterior surface 540 and an interior first friction surface 542 which can be arcuate or partially conical in shape, and more desirably comprises a conical or frustoconical shaped friction surface 542 in this illustrated embodiment.

FIGS. 41, 42 and 43 illustrate an embodiment of a pivot member engager in the form of a compression ratio adjuster 550 comprising a body 551 including at least one and desirably plural pivot member engagement surfaces 552, 554. FIG. 42 is a sectional view of the compression ratio adjuster of FIG. 41 taken along line 42-42 of FIG. 41. As can be seen from FIG. 42, compression ratio adjuster 550 comprises a second friction surface 551 configured to engage the first friction surface of the adjuster retainer. Friction surface 551 desirably comprises an arcuate or partially conical friction surface and in FIG. 42 is shown with a desirable conical or frustoconical external friction surface 560 that is shaped to closely fit the interior surface 542 of the first braking member. In addition, the distal end portion of compression ratio adjuster 550, opposite to the end portion defining pivot member engagement surface 552, has aligned openings 562, 564 through which an end portion of a friction applying and rotational imparting engagement spring can be inserted to engage the compression ratio adjuster 550.

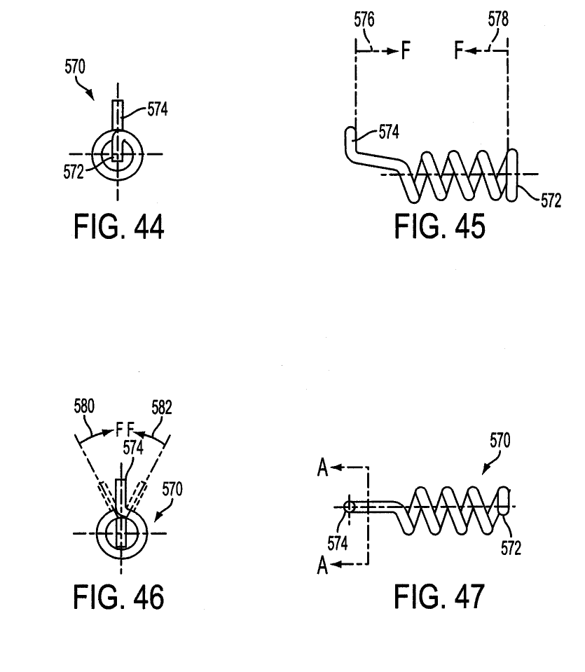

FIGS. 44, 45, 46 and 47 illustrate an exemplary spring 570 that can be used to apply the desired forces to the compression ratio adjuster and adjuster retainer. Spring 570 can be a coil spring, such as shown. Again, as previously described, more than one spring can be used for biasing purposes and alternative forms of biasing mechanisms can be used. Spring 570 comprises a first end portion 572 that can be inserted through the openings 562, 564 of the compression ratio adjuster (see FIG. 42) to couple the spring 570 to the compression ratio adjuster. End portion 572 extends downwardly in FIG. 45. As can be seen from these figures, the opposite end portion 574 of the spring 570 is configured for engaging the piston pin. More specifically, end portion 574 can be upwardly extending for positioning in the respective slots 488, 488d and 488e of the piston pins 480, 500 and 520, shown in FIGS. 29, 33 and 36 above. Forces indicated schematically by arrows 576 and 578 in FIG. 45 illustrate the exertion of force against the compression ratio adjuster that pulls the second friction surface 560 (FIG. 42) of the compression ratio adjuster axially inwardly and against the first friction surface 542 (FIG. 39) of the adjuster retainer. Forces indicated schematically by arrows 580, 582 in FIG. 46 illustrate the rotational forces exerted by the biasing spring 570 against the coupled piston pin that arises as a result of the adjustment of the rotational position of the compression ratio adjuster 550 when it engages the pivot member or turning member at, for example, the bottom dead center position of the piston. As previously explained, the compression ratio adjuster is in effect pre-loaded by the spring so that, as the connecting rod passes through a low force area moving toward the top dead center position, the rotational energy stored by the spring applies a force that causes the rotation of the piston pin and eccentric portion thereof to the position established by the compression ratio adjuster to thereby vary the compression ratio of the engine.

FIGS. 48, 49 and 50 illustrate an embodiment with a piston coupler in the form of piston pin 480 installed in a piston. In these embodiments, the spring 570, adjuster retainer 530, and compression ratio adjuster 550 are shown in position.

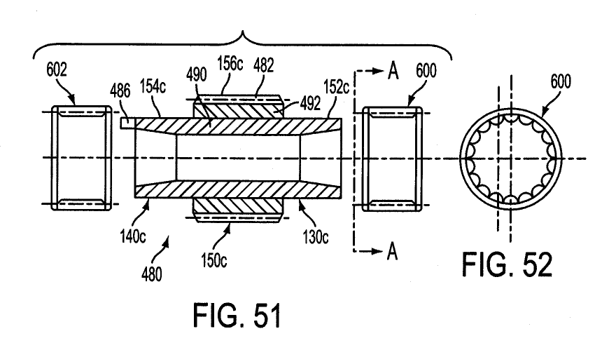

FIG. 51 illustrates a piston pin 480 like the piston pin shown in FIG. 28. Consequently, components of the piston pin of FIG. 51 in common with those of FIG. 28 have been given the same numbers. In FIG. 51, first and second needle bearings 600, 602 are shown in position for engaging the respective piston pin surfaces 152c of pin section 130c and surface 154c of piston pin portion 140c. FIG. 52 illustrates an end view of the needle bearing 600. Needle bearings are conventional. The use of needle bearings is advantageous as they minimize uneven wear on the piston pin in cases where the piston pin only swings with the connecting rod through a limited angle and reduce friction torque.

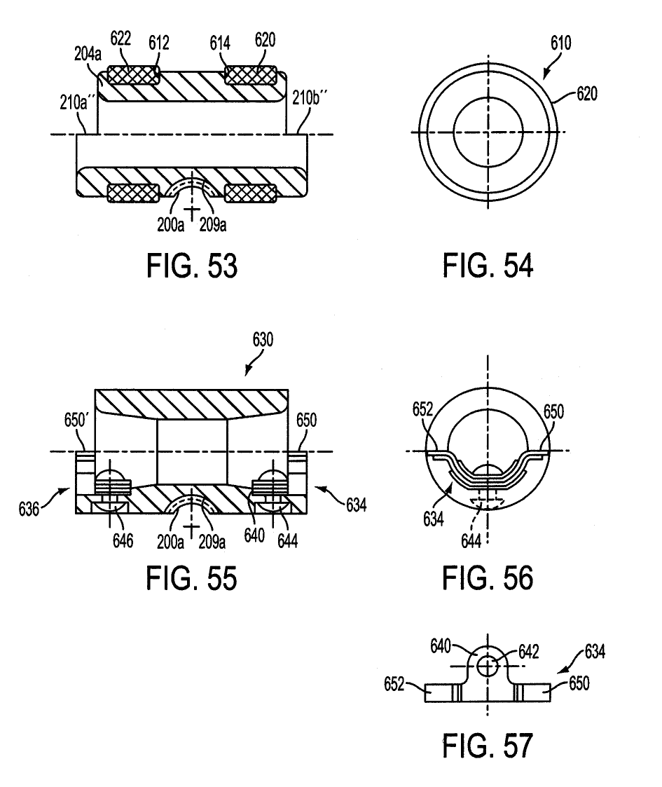

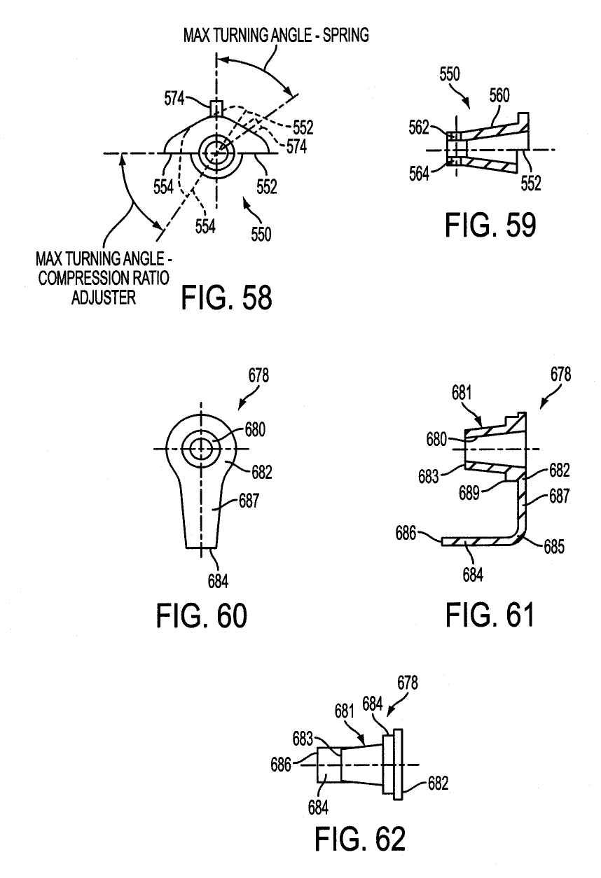

A pivot member or turning member, such as shown in FIG. 8, and alternatively, in FIGS. 9 and 9A, with respective eccentric engagement surfaces for engaging the corresponding engagement surfaces of the compression ratio adjuster can be used to adjust the compression ratio. However, alternative pivot member embodiments can be used, such as shown in FIGS. 53 through 57. These latter embodiments are designed to provide some resiliency, or give, when the compression ratio adjuster engages the turning member at the bottom dead center position to thereby provide dampening when such engagement takes place. In the embodiments of FIGS. 53 through 57, components in common with the components shown in FIG. 9A have been assigned the same numbers and will not be discussed in detail. It should be noted that dampening modifications can also be made to the pivot member embodiments of FIGS. 8, 9 and 9A. The pivot member 610 shown in FIGS. 53 and 54 can be provided with a central area of reduced cross-sectional dimension, such as shown at 202a in FIG. 9A, if desired. To provide dampening, resilient material can be interposed between the pivot member and adjacent supporting structure, such as supporting brackets or supporting surfaces of the engine. As a specific example, in FIG. 53, first and second annular grooves 612, 614 can be provided in the pivot member. Groove 614 is positioned between the midpoint of pivot member 610 and a compression ratio adjuster or adjuster engagement surface 210b″. In addition, groove 612 is positioned between the midpoint of the pivot member and a compression ratio adjuster or adjuster engagement surface 210a″. An annular ring of resilient material 620 is positioned in groove 614 and a similar annular ring of resilient material 622 is positioned within groove 612. Material 620, 622 can be a polymer, and can be an elastic or elastomeric material, with rubber being one specific example. As can be seen in FIG. 54, in the illustrated embodiment the resilient material 620 projects outwardly beyond the exterior surfaces of the supporting body portion of the pivot member.

In the embodiment shown in FIGS. 55, 56, and 57, multi-leaf spring assemblies 634, 636 are used to provide dampening. In this specific embodiment, the spring assemblies 634, 636 define the respective compression ratio adjuster engagement surfaces of the pivot member. As can been seen in FIG. 57, for leaf spring 634, each leaf spring can comprise a base portion 640 having a fastener receiving opening 642 through which a fastener 644 (see FIG. 56) can be inserted to mount the leaf spring to the body of the pivot member 630. A similar fastener 646 can be used to mount the leaf spring 636 in place. In an example wherein the compression ratio adjuster engagement surfaces are provided at opposite sides of the center line of the pivot member, the leaf spring 634 defines respective first and second engagement surfaces 650, 652, for engaging the respective compression ratio adjuster surfaces 552, 554 (see FIG. 41) as the piston arrives at the bottom dead center position. Only one of such engagement surfaces 650′ is shown in FIG. 55 for the leaf spring member 636.

Thus, FIGS. 53 through 57 illustrate examples of dampened pivot members suitable for engaging pivot member engagers such as the engagement surfaces of a compression ratio adjuster 550, such as shown in FIG. 41. The friction between the compression ratio adjuster and the adjuster retainer, defined by the axial spring force in one embodiment, the cone angle of the friction surfaces in this embodiment, and the friction coefficient (steel/steel oiled, for example) is such that the compression ratio adjuster will be turned with the spring being loaded with a torsional force when the compression ratio adjuster has been turned by the pivot member.

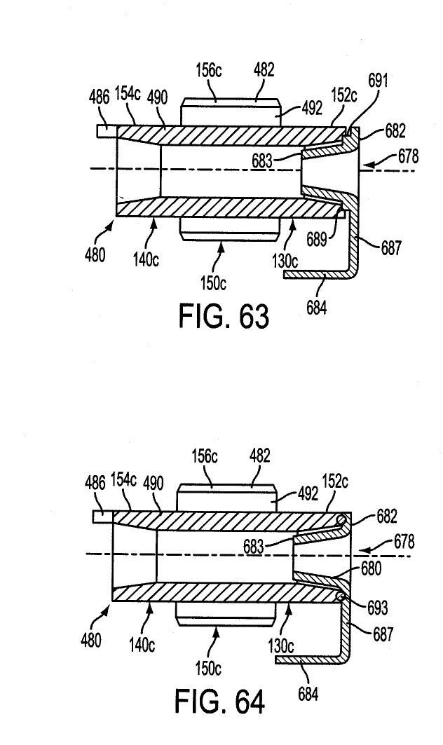

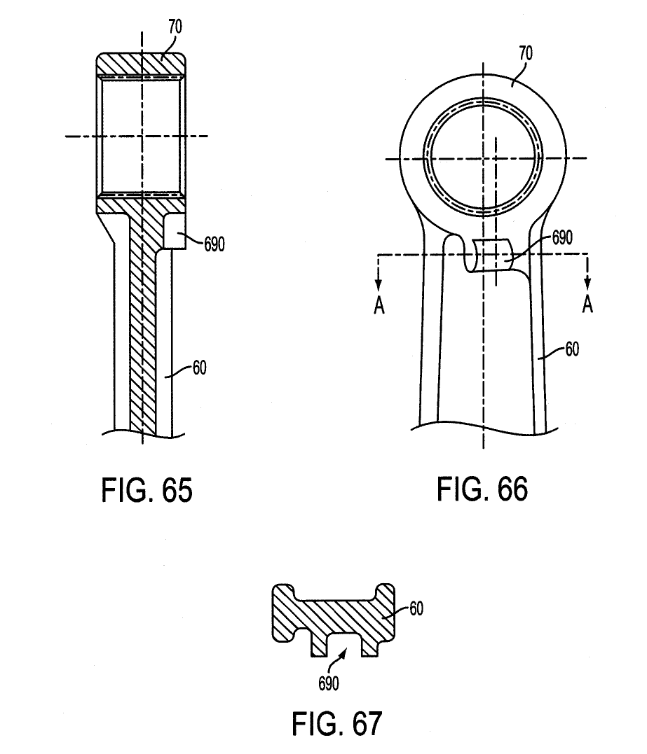

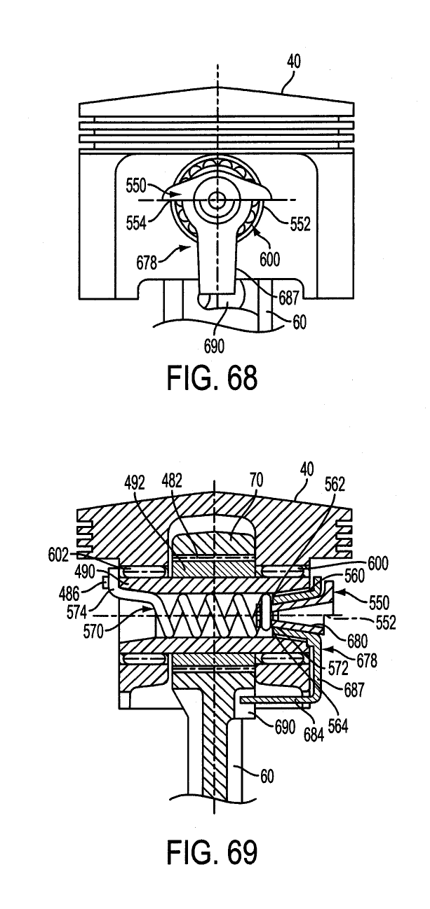

FIGS. 60 through 67 illustrate an alternative embodiment wherein the adjuster retainer is configured to engage the connecting rod instead of the piston. This reduces the sensitivity of the system to crankshaft position when the compression in the connecting rod changes to tension, prior to the piston reaching the top dead center position. When the compression ratio adjuster is turned by the pivot member, at times when a change in the compression ratio is to be accomplished, the torque is higher than the friction torque and the compression ratio adjuster is shifted to a new position. As a result, a torsion force in the spring is built up and the piston pin will be turned as soon as the load is low, that is as the compression in the connecting rod approaches a change between tension and compression. In accordance with this embodiment, one example of a modified adjuster retainer is indicated at 678 in FIGS. 60-64. The adjuster retainer 678 is configured to provide a friction engagement surface 680, that can be as previously described, such as conical or frustoconical, for engaging the exterior surface of the compression ratio adjuster, as previously described. Surface 680 is positioned at the interior of the frustoconical projection portion 681 of the adjuster retainer 678. The base portion 682, positioned opposed to a distal end portion 683 of the friction structure is shown in these figures. A first leg portion 687 of the adjuster retainer projects downwardly from base 682 and is joined at its lower end portion 685 to an inwardly projecting leg portion 684 that terminates in a distal end 686. Adjuster retainer 678 can be provided with a projection from base 682 toward end 683, such as an annular shelf 689, that engages or fits into a corresponding recess 691 in the piston pin (see FIG. 63). Alternatively, a bearing receiving recess can be provided in the base for receiving a portion of a bearing 693 that is also recessed partially into the adjacent end of piston pin 480 (see FIG. 64). The structure 683, 684, 685 and 686 comprises one form of a flange or finger-like connecting rod engagement structure, it being understood that alternative forms of such a structure can be utilized.

FIGS. 63, 64, and 65 illustrate an exemplary form of connecting rod 60 configured to define a slot 690 for receiving a portion of the distal end 686 of leg 684 of the connecting rod engagement structure of the adjuster retainer 678. As a result, the adjuster retainer is coupled in this example to the connecting rod, instead of being mounted directly to the piston.

FIGS. 66 and 67 illustrate an exemplary piston assembly utilizing needle bearings and an adjuster retainer 678 of the form shown in FIGS. 60 through 62 and a connecting rod as shown in FIGS. 63 through 65.

With these desirable constructions, adjustment of the compression ratio is delayed from the time a pivot member engager of a pivot pin engages and is turned by a pivot member at the bottom dead center position until such time as a connecting rod approaches a transition between compression and tension. That is, to adjust the compression ratio, the position of a compression ratio adjuster is shifted by a pivot member when the piston is in a bottom dead center position. The movement of the compression ratio adjuster preloads a biasing member, such as a spring, with a torsional adjustment force. As a connecting rod approaches a low force condition, the preloaded torsional force pivots and adjusts the position of the associated piston pin (and an eccentric thereof) to thereby adjust the compression ratio.

Having illustrated and described the principles of my invention with reference to exemplary embodiments, it should be apparent to those of ordinary skill in the art that these elements can be modified in arrangement and detail without departing from the inventive principles disclosed herein. I claim all such modifications.

I claim:

1. An internal combustion engine comprising:
a rotatable crank shaft;
at least one piston cylinder;
a piston slidably received by said at least one cylinder so as to reciprocate between top dead center and bottom dead center positions within said cylinder, the piston comprising a first piston coupler receiving bore that defines a first axis;
a connecting rod comprising a crank coupling end portion pivotally coupled to the crank shaft such that rotation of the crank shaft causes the connecting rod to reciprocate, the connecting rod comprising a piston coupling end portion comprising a second piston coupler receiving bore that defines a second axis;
a piston coupler comprising a first coupler portion pivotally received by said first piston coupler receiving bore so as to be pivotable about the first axis, the piston coupler comprising a second coupler portion pivotally received by the second piston coupler receiving bore to couple the connecting rod to the piston such that reciprocation of the connecting rod causes the piston to reciprocate between the top dead center and bottom dead center positions, one of the first and the second coupler portion comprising an eccentric portion comprising a threaded portion that is threadedly coupled to the connecting rod within the second piston coupler receiving bore such that pivoting of the piston coupler about the first axis from a first coupler position to a second coupler position pivots the eccentric portion from a first eccentric position to a second eccentric position and shifts the second axis relative to the first axis to thereby vary the compression ratio of said at least one cylinder;
an adjuster retainer coupled to the piston or to the connecting rod;
a compression ratio adjuster pivotally and frictionally coupled to the adjuster retainer so as to permit pivoting about the first axis in response to a torsionally applied force with the adjuster retainer applying frictional resistance to such pivoting of the compression ratio adjuster, the compression ratio adjuster comprising at least one pivot member engager;
a biasing member coupling the compression ratio adjuster to the pivot coupler;
a pivot member comprising a compression ratio adjuster engager movable from a first adjuster engager position to a second adjuster engager position and positioned to engage the pivot member engager to pivot the compression ratio adjuster relative to the adjuster retainer and relative to the pivot coupler from a first compression ratio adjuster position to a second compression ratio adjuster position as the piston approaches the bottom dead center position, such movement by the first compression ratio adjuster loading the biasing member with torsional biasing energy, the compression ratio adjuster disengaging from the pivot member and the torsional biasing energy pivoting the pivot coupler from the first coupler position to the second coupler position as the piston travels away from the bottom dead center position to a position where compression and tension forces in the connecting rod are insufficient to resist pivoting of the piston coupler.

2. An internal combustion engine according to claim 1 wherein the pivot member is pivotable about a pivot member axis, the pivot member being pivotable about the pivot member axis from a first pivot member position to a second pivot member position to pivot the compression adjuster engager from the first adjuster engager position to the second adjuster engager position, the compression ratio adjuster being pivoted from the first compression ratio adjuster position to the second compression ratio adjuster position as the piston approaches the bottom dead center position in response to the pivoting of the compression ratio adjuster engager from the first adjuster engager position to the second adjuster engager position.

3. An internal combustion engine according to claim 2 wherein the pivot member engager comprises at least one pivot member engagement surface and wherein the compression ratio adjuster engager comprises at least one adjuster engagement surface, the at least one adjuster engagement surface being pivoted from a first adjuster engagement surface position to a second adjuster engagement surface position in response to pivoting of the pivot member from the first adjuster engager position to the second adjuster engager position, the at least one pivot member engagement surface and at least one adjuster engagement surface being positioned to engage one another as the piston approaches the bottom dead center position to pivot the compressor ratio adjuster from the first compression ratio adjuster position to the second compression ratio adjuster position in response to the pivoting of the at least one adjuster engagement surface from the first adjuster engagement surface position to the second adjuster engagement surface position.

4. An internal combustion engine according to claim 3 wherein the at least one compression ratio adjuster engagement surface and the at least one pivot member engagement surface are flat surfaces.

5. An internal combustion engine according to claim 3 wherein the at least one compression ratio adjuster engagement surface and the at least one pivot member engagement surface are planar surfaces.

6. An internal combustion engine according to claim 3 wherein there are two of said pivot member engagement surfaces positioned on opposite sides of the first axis and wherein there is a first set of two compression ratio adjuster engagement surfaces on opposite sides of the pivot member axis.

7. An internal combustion engine according to claim 6 wherein said compression ratio adjuster engagement surfaces and said pivot member engagement surfaces are flat surfaces.

8. An internal combustion engine according to claim 1 wherein the piston coupler comprises a piston pin pivotable about the first axis, and wherein the at least one piston comprises a body having an upper cylindrical piston ring supporting portion of a first diameter and a lower body portion sized to create a compression ratio adjuster receiving space between the lower body portion and the at least one cylinder, one end portion of the compression ratio adjuster extending outwardly from the lower body portion into the compression ratio adjuster receiving space.

9. An internal combustion engine according to claim 8 wherein the compression ratio adjuster engager comprises downwardly facing first and second pivot member engagement surfaces.

10. An internal combustion engine according to claim 6 wherein there are first and second of said piston cylinders, a respective associated first piston slidably received by the first of said piston cylinders and a respective associated second piston slidably received by the second of said piston cylinders, a respective connecting rod and piston coupler associated with and coupled to said first piston, a respective connecting rod and piston coupler associated with and coupled to the second piston, an adjuster retainer and a compression ratio adjuster associated with the piston coupler associated with the first piston, an adjuster retainer and a compression ratio adjuster associated with the piston coupler associated with the second piston, and wherein there is a common pivot member for engaging the respective compression ratio adjusters associated with the first and second pistons, the pivot member comprising a first set of two adjuster engagement surfaces for engaging the two pivot member engagement surfaces of the compression ratio adjuster associated with the first piston and a second set of two adjuster engagement surfaces for engaging the two pivot member engagement surfaces of the compression ratio adjuster associated with the second piston.

11. An internal combustion engine according to claim 10 wherein there is at least one additional of said piston cylinders and pistons in addition to the first and second pistons and first and second piston cylinders, each said additional piston cylinder comprising an associated compression ratio adjuster, piston coupler, connecting rod and pivot member.

12. An internal combustion engine according to claim 3 comprising a worm gear drivenly coupled to said pivot member, a motor coupled to the worm gear and operable to pivot the pivot member from plural first positions to plural second positions to adjust the compression ratio to a plurality of values.

13. An internal combustion engine according to claim 12 wherein the pivot member defines a recess extending in a direction perpendicular to the pivot member axis, the worm gear being positioned at least partially in the recess and engaging the pivot member to restrict movement of the pivot member in either direction along the pivot member axis.

14. An internal combustion engine according to claim 12 wherein the worm gear engages the pivot member and restricts movement of the pivot member in either direction along the pivot member axis.

15. An internal combustion engine according to claim 1 wherein there are a plurality of said piston cylinders, each with an associated piston, piston coupler, connecting rod, adjuster retainer, compression ratio adjuster and pivot member, a single worm gear drive motor, and a plurality of worm gears operable to pivot said pivot members in response to the operation of said worm gear drive motor.

16. An internal combustion engine according to claim 15 wherein there is at least one pivot member operable to pivot at least two compression ratio adjusters.

17. An internal combustion engine according to claim 12 wherein the worm gear is configured to restrict pivoting of the pivot member to be within a predetermined limit.

18. An internal combustion engine according to claim 17 wherein the predetermined limit is approximately one hundred and ten degrees, and wherein the center position of the limit corresponds to the pivot coupler being pivoted to a position that aligns the first axis and the second axis.

19. An internal combustion engine according to claim 1 wherein the piston coupler comprises a piston pin comprising first and third portions and a second portion intermediate to the first and third portions, the first and third portions having longitudinal centerlines that are aligned with the first axis, the second portion comprising the eccentric portion and having a longitudinal center line that is aligned with the second axis, the first, second and third portions comprising right cylindrical surfaces of respective first, second and third diameters, at least a portion of the surface of the second portion being threaded, and wherein the compression ratio adjuster is carried by an end portion of the first portion of the piston pin.

20. An internal combustion engine according to claim 19 wherein the pivot member engager comprises at least one pivot member engagement surface and wherein the compression ratio adjuster engager comprises at least one adjuster engagement surface, the at least one adjuster engagement surface being pivoted from a first position to a second position in response to pivoting of the pivot member from the first pivot member position to the second pivot member position, the at least one pivot member engagement surface and at least one adjuster engagement surface being positioned to engage one another as the piston approaches the bottom dead center position to pivot the compression ratio adjuster from the first compression ratio adjuster position to the second compression ratio adjuster position in response to the pivoting of the at least one adjuster engagement surface from the first position of the adjuster engagement surface to the second position of the adjuster engagement surface.
a worm gear drivenly coupled to said pivot member, a motor coupled to the worm gear and operable to pivot the pivot member from plural first positions to plural second positions to adjust the compression ratio to a plurality of values; and
wherein the worm gear engages the pivot member and restricts movement of the pivot member in either direction along the pivot member axis.

21. An internal combustion engine according to claim 19 wherein the first diameter is equal to the third diameter and the second diameter is greater than the first and third diameters, the first piston coupler receiving bore comprising right cylindrical first and second piston bore portions having a diameter that is greater than the second diameter such that the piston pin is insertable in one direction through the first piston bore portion, the piston coupler receiving bore and the second piston bore portion, a first bushing mounted to the first piston pin portion and positioned within the first piston bore portion and a second bushing mounted to the third piston pin portion and positioned within the second piston bore portion.

22. An internal combustion engine according to claim 2 wherein the piston cylinder has a longitudinal centerline and wherein the maximum eccentricity is defined as E and corresponds to the maximum offset between the first and second axes, wherein an origin of a reference coordinate system is at the intersection of the longitudinal centerline of the at least one piston cylinder and a bottom dead centerline corresponding the second axis when the second axis is in the bottom dead center position, wherein the Z dimension is along the longitudinal center line of the piston cylinder from the origin and the X dimension is along the bottom dead centerline from the origin, wherein the pivot member axis is parallel to the first axis and, wherein the pivot member axis intersects an area wherein X is from −0.5E to −0.8E and Z is from −0.25E to 0.25E.

23. An internal combustion engine according to claim 2 wherein the piston cylinder has a longitudinal centerline, wherein the longitudinal centerline is positioned between a first line parallel to the longitudinal centerline that intersects the first axis and a second line parallel to the longitudinal centerline that intersects the second axis when the eccentric portion is pivoted to the maximum allowed extent.

24. An internal combustion engine according to claim 2 wherein the maximum eccentricity is defined as E and corresponds to the maximum offset between the first and second axes arising from pivoting the eccentric portion, wherein the piston coupler comprises a piston pin comprising first and third portions and a second portion intermediate the first and third portions, the first and third portions having longitudinal centerlines that are aligned with the first axis, the second portion comprising the eccentric portion and having a longitudinal center line that is aligned with the second axis, the first, second and third portions comprising right cylindrical surfaces, the second portion having a right cylindrical surface of a first radius defined as R_{CR}, one of the first and third portions having a right cylindrical surface of a radius R₁, wherein R₁≧(R_{CR}+E), and the other of the first and third portions having a right cylindrical surface of a radius R₂, wherein R₂≦(R_{CR}−E).

25. An internal combustion engine according to claim 1 wherein the adjuster retainer is fixedly mounted to the piston.

26. An internal combustion engine according to claim 1 wherein the adjuster retainer is coupled to the piston pin and also to the connecting rod, but is not fixedly mounted to the piston.

27. An internal combustion engine according to claim 26 wherein the connecting rod defines a pivot limiting slot, and wherein the adjuster retainer comprises a slot engaging portion extending into the slot, the slot limiting rotational motion of the adjuster retainer.

28. An internal combustion engine according to claim 1 wherein the piston coupler comprises a piston pin, wherein the adjuster retainer defines a first friction surface, and wherein the compression ratio adjuster comprises a second friction surface positioned to frictionally engage the first friction surface, the biasing member comprising a spring coupled to the piston pin and to the compression ratio adjuster and operable to apply force in a direction that urges the first and second friction surfaces axially together and that is loaded with a torsional force upon pivoting of the compression ratio adjuster relative to the piston pin.

29. An internal combustion engine according to claim 28 wherein each of the first and second friction surfaces are at least partially conical, the piston pin comprising first and second end portions, the first end portion comprising an adjuster retainer receiving first cavity into which the adjuster retainer is at least partially inserted, the adjuster retainer defining a compression ratio adjuster receiving cavity with the first friction surface comprising a portion of the adjuster retainer bounding the compression ratio adjuster receiving cavity, the compression ratio adjuster being at least partially inserted into the compression ratio adjuster receiving cavity with the second friction surface being a portion of an exterior surface of the compression ratio adjuster and positioned to engage the first friction surface.

30. An internal combustion engine according to claim 29 wherein the second end portion of the piston pin defines a second cavity, the piston pin further comprising an internal cavity interconnecting the first and second cavities, the internal cavity and the first and second cavities being shaped and dimensioned to achieve a homogenous bending line in response to the application of force by the piston to the piston pin and the counterforce applied by the connecting rod to the piston pin during operation of the engine.

31. An internal combustion engine according to claim 30 wherein the pivot member engager comprises an outwardly projecting portion of the compression ratio adjuster.

32. An internal combustion engine according to claim 1 wherein the pivot member engager comprises an outwardly projecting portion of the compression ratio adjuster.

33. An internal combustion engine according to claim 10 wherein the common pivot member comprises a first pivot member end portion extending into a first region defined by the first cylinder and a second pivot member end portion extending into a second region defined by the second cylinder, a first bracket coupled to the first cylinder in a position to pivotally support the first pivot member end portion, a second bracket coupled to the second cylinder in a position to pivotally support the second pivot member end portion, the first and second brackets being fastened together with a portion of the first cylinder and a portion of the second cylinder positioned between the first and second brackets, the first and second brackets being shaped to provide clearance for the respective pivot member engagement surfaces and adjuster engagement surfaces to engage one another.

34. An internal combustion engine comprising:
a rotatable crank shaft;
at least one piston cylinder;
a piston slidably received by said at least one cylinder so as to reciprocate between top dead center and bottom dead center positions within said cylinder, the piston comprising a first piston coupler receiving bore that defines a first axis;
a connecting rod comprising a crank coupling end portion pivotally coupled to the crank shaft such that rotation of the crank shaft causes the connecting rod to reciprocate, the connecting rod comprising a piston coupling end portion comprising a second piston coupler receiving bore that defines a second axis;
a piston coupler comprising a first coupler portion pivotally received by said first piston coupler receiving bore so as to be pivotable about the first axis, the piston coupler comprising a second coupler portion pivotally received by the second piston coupler receiving bore to couple the connecting rod to the piston such that reciprocation of the connecting rod causes the piston to reciprocate between the top dead center and bottom dead center positions, one of the first and the second coupler portion comprising an eccentric portion comprising a threaded portion that is threadedly coupled to the connecting rod within the second piston coupler receiving bore such that pivoting of the piston coupler about the first axis from a first coupler position to a second coupler position pivots the eccentric portion from a first eccentric position to a second eccentric position and shifts the second axis relative to the first axis to thereby vary the compression ratio of said at least one cylinder;
an adjuster retainer coupled to the piston or to the connecting rod;
a compression ratio adjuster pivotally and frictionally coupled to the adjuster retainer so as to permit pivoting about the first axis in response to a torsionally applied force with the adjuster retainer applying frictional resistance to such pivoting of the compression ratio adjuster, the compression ratio adjuster comprising at least one pivot member engager;
a biasing member coupling the compression ratio adjuster to the pivot coupler;
a pivot member comprising a compression ratio adjuster engager movable from a first adjuster engager position to a second adjuster engager position and positioned to engage the pivot member engager to pivot the compression ratio adjuster relative to the adjuster retainer and relative to the pivot coupler from a first compression ratio adjuster position to a second compression ratio adjuster position as the piston approaches the bottom dead center position, such movement by the first compression ratio adjuster loading the biasing member with torsional biasing energy, the compression ratio adjuster disengaging from the pivot member, the torsional biasing energy pivoting the pivot coupler from the first coupler position to the second coupler position as the piston travels away from the bottom dead center position to a position where compression and tension forces in the connecting rod are insufficient to resist pivoting of the piston coupler;
wherein the piston coupler comprises a piston pin comprising first and third portions and a second portion intermediate to the first and third portions, the first and third portions having longitudinal centerlines that are aligned with the first axis, the second portion comprising the eccentric portion and having a longitudinal center line that is aligned with the second axis, the first, second and third portions comprising right cylindrical surfaces of respective first, second and third diameters, at least a portion of the surface of the second portion being threaded, and wherein the compression ratio adjuster is carried by an end portion of the first portion of the piston pin;
wherein the first diameter is equal to the third diameter and the second diameter is greater than the first and third diameters, the first piston coupler receiving bore comprising right cylindrical first and second piston bore portions having a diameter that is greater than the second diameter such that the piston pin is insertable in one direction through the first piston bore portion, the piston coupler receiving bore and the second piston bore portion, a first bushing mounted to the first piston pin portion and positioned within the first piston bore portion and a second bushing mounted to the third piston pin portion and positioned within the second piston bore portion.

35. An internal combustion engine according to claim 34 wherein the adjuster retainer defines a first friction surface, and wherein the compression ratio adjuster comprises a second friction surface positioned to frictionally engage the first friction surface, the biasing member comprising a spring coupled to the piston pin and to the compression ratio adjuster and operable to apply force in a direction that urges the first and second friction surfaces axially together and that is loaded with a torsional force upon pivoting of the compression ratio adjuster relative to the piston pin.

36. An internal combustion engine according to claim 35 wherein each of the first and second friction surfaces are at least partially conical, the piston pin comprising first and second end portions, the first end portion comprising an adjuster retainer receiving first cavity into which the adjuster retainer is at least partially inserted, the adjuster retainer defining a compression ratio adjuster receiving cavity with the first friction surface comprising a portion of the adjuster retainer bounding the compression ratio adjuster receiving cavity, the compression ratio adjuster being at least partially inserted into the compression ratio adjuster receiving cavity with the second friction surface being a portion of an exterior surface of the compression ratio adjuster and positioned to engage the first friction surface.

37. An internal combustion engine comprising:
a rotatable crank shaft;
at least one piston cylinder;
a piston slidably received by said at least one cylinder so as to reciprocate between top dead center and bottom dead center positions within said cylinder, the piston comprising a first piston coupler receiving bore that defines a first axis;
a connecting rod comprising a crank coupling end portion pivotally coupled to the crank shaft such that rotation of the crank shaft causes the connecting rod to reciprocate, the connecting rod comprising a piston coupling end portion comprising a second piston coupler receiving bore that defines a second axis;
a piston coupler comprising a first coupler portion pivotally received by said first piston coupler receiving bore so as to be pivotable about the first axis, the piston coupler comprising a second coupler portion pivotally received by the second piston coupler receiving bore to couple the connecting rod to the piston such that reciprocation of the connecting rod causes the piston to reciprocate between the top dead center and bottom dead center positions, one of the first and the second coupler portion comprising an eccentric portion comprising a threaded portion that is threadedly coupled to the connecting rod within the second piston coupler receiving bore such that pivoting of the piston coupler about the first axis from a first coupler position to a second coupler position pivots the eccentric portion from a first eccentric position to a second eccentric position and shifts the second axis relative to the first axis to thereby vary the compression ratio of said at least one cylinder;
an adjuster retainer coupled to the piston or to the connecting rod;
a compression ratio adjuster pivotally and frictionally coupled to the adjuster retainer so as to permit pivoting about the first axis in response to a torsionally applied force with the adjuster retainer applying frictional resistance to such pivoting of the compression ratio adjuster, the compression ratio adjuster comprising at least one pivot member engager;
a biasing member coupling the compression ratio adjuster to the pivot coupler;
a pivot member comprising a compression ratio adjuster engager movable from a first adjuster engager position to a second adjuster engager position and positioned to engage the pivot member engager to pivot the compression ratio adjuster relative to the adjuster retainer and relative to the pivot coupler from a first compression ratio adjuster position to a second compression ratio adjuster position as the piston approaches the bottom dead center position, such movement by the first compression ratio adjuster loading the biasing member with torsional biasing energy, the compression ratio adjuster disengaging from the pivot member, the torsional biasing energy pivoting the pivot coupler from the first coupler position to the second coupler position as the piston travels away from the bottom dead center position to a position where compression and tension forces in the connecting rod are insufficient to resist pivoting of the piston coupler;
wherein the pivot member is pivotable about a pivot member axis, the pivot member being pivotable about the pivot member axis from a first pivot member position to a second pivot member position to pivot the compression adjuster engager from the first adjuster engager position to the second adjuster engager position, the compression ratio adjuster being pivoted from the first compression ratio adjuster position to the second compression ratio adjuster position as the piston approaches the bottom dead center position in response to the pivoting of the compression ratio adjuster engager from the first adjuster engager position to the second adjuster engager position;
wherein the pivot member engager comprises at least one pivot member engagement surface and wherein the compression ratio adjuster engager comprises at least one adjuster engagement surface, the at least one adjuster engagement surface being pivoted from a first adjuster engagement surface position to a second adjuster engagement surface position in response to pivoting of the pivot member from the first adjuster engager position to the second adjuster engager position, the at least one pivot member engagement surface and at least one adjuster engagement surface being positioned to engage one another as the piston approaches the bottom dead center position to pivot the compressor ratio adjuster from the first compression ratio adjuster position to the second compression ratio adjuster position in response to the pivoting of the at least one adjuster engagement surface from the first adjuster engagement surface position to the second adjuster engagement surface position;
wherein there are two of said pivot member engagement surfaces positioned on opposite sides of the first axis and wherein there is a first set of two compression ratio adjuster engagement surfaces on opposite sides of the pivot member axis;
wherein the piston coupler comprises a piston pin pivotable about the first axis, and wherein the at least one piston comprises a body having an upper cylindrical piston ring supporting portion of a first diameter and a lower body portion sized to create a compression ratio adjuster receiving space between the lower body portion and the at least one cylinder, one end portion of the compression ratio adjuster extending outwardly from the lower body portion into the compression ratio adjuster receiving space.
wherein there are first and second of said piston cylinders, a respective associated first piston slidably received by the first of said piston cylinders and a respective associated second piston slidably received by the second of said piston cylinders, a respective connecting rod and piston coupler associated with and coupled to said first piston, a respective connecting rod and piston coupler associated with and coupled to the second piston, an adjuster retainer and a compression ratio adjuster associated with the piston coupler associated with the first piston, an adjuster retainer and a compression ratio adjuster associated with the piston coupler associated with the second piston, and wherein there is a common pivot member for engaging the respective compression ratio adjusters associated with the first and second pistons, the pivot member comprising a first set of two adjuster engagement surfaces for engaging the two pivot member engagement surfaces of the compression ratio adjuster associated with the first piston and a second set of two adjuster engagement surfaces for engaging the two pivot member engagement surfaces of the compression ratio adjuster associated with the second piston;
a worm gear drivenly coupled to said pivot member, a motor coupled to the worm gear and operable to pivot the pivot member from plural first positions to plural second positions to adjust the compression ratio to a plurality of values;
wherein the worm gear engages the pivot member and restricts movement of the pivot member in either direction along the pivot member axis;
wherein the piston coupler comprises a piston pin comprising first and third portions and a second portion intermediate to the first and third portions, the first and third portions having longitudinal centerlines that are aligned with the first axis, the second portion comprising the eccentric portion and having a longitudinal center line that is aligned with the second axis, the first, second and third portions comprising right cylindrical surfaces of respective first, second and third diameters, at least a portion of the surface of the second portion being threaded, and wherein the compression ratio adjuster is carried by an end portion of the first portion of the piston pin.

38. An internal combustion engine according to claim 37 wherein the piston coupler comprises a piston pin, wherein the adjuster retainer defines a first friction surface, and wherein the compression ratio adjuster comprises a second friction surface positioned to frictionally engage the first friction surface, the biasing member comprising a spring coupled to the piston pin and to the compression ratio adjuster and operable to apply force in a direction that urges the first and second friction surfaces axially together and that is loaded with a torsional force upon pivoting of the compression ratio adjuster relative to the piston pin;
wherein each of the first and second friction surfaces are at least partially conical, the piston pin comprising first and second end portions, the first end portion comprising an adjuster retainer receiving first cavity into which the adjuster retainer is at least partially inserted, the adjuster retainer defining a compression ratio adjuster receiving cavity with the first friction surface comprising a portion of the adjuster retainer bounding the compression ratio adjuster receiving cavity, the compression ratio adjuster being at least partially inserted into the compression ratio adjuster receiving cavity with the second friction surface being a portion of an exterior surface of the compression ratio adjuster and positioned to engage the first friction surface.

39. An internal combustion engine according to claim 38 wherein the second end portion of the piston pin defines a second cavity, the piston pin further comprising an internal cavity interconnecting the first and second cavities, the internal cavity and the first and second cavities being shaped and dimensioned to achieve a homogenous bending line in response to the application of force by the piston to the piston pin and the counterforce applied by the connecting rod to the piston pin during operation of the engine.

40. An internal combustion engine according to claim 38 wherein the adjuster retainer is fixedly mounted to the piston.

41. An internal combustion engine according to claim 38 wherein the adjuster retainer is coupled to the piston pin and also to the connecting rod, but is not fixedly mounted to the piston.

42. An internal combustion engine according to claim 41 wherein the connecting rod defines a pivot limiting slot, and wherein the adjuster retainer comprises a slot engaging portion extending into the slot, the slot limiting rotational motion of the adjuster retainer.

43. An internal combustion engine according to claim 37 wherein the piston cylinder has a longitudinal centerline and wherein the maximum eccentricity is defined as E and corresponds to the maximum offset between the first and second axes, wherein an origin of a reference coordinate system is at the intersection of the longitudinal centerline of the at least one piston cylinder and a bottom dead centerline corresponding the second axis when the second axis is in the bottom dead center position, wherein the Z dimension is along the longitudinal center line of the piston cylinder from the origin and the X dimension is along the bottom dead centerline from the origin, wherein the pivot member axis is parallel to the first axis and, wherein the pivot member axis intersects an area wherein X is from −0.5E to −0.8E and Z is from −0.25E to 0.25E.

44. An internal combustion engine according to claim 37 wherein the piston cylinder has a longitudinal centerline, wherein the longitudinal centerline is positioned between a first line parallel to the longitudinal centerline that intersects the first axis and a second line parallel to the longitudinal centerline that intersects the second axis when the eccentric portion is pivoted to the maximum allowed extent.

45. An internal combustion engine according to claim 37 wherein the maximum eccentricity is defined as E and corresponds to the maximum offset between the first and second axes arising from pivoting the eccentric portion, the first, second and third portions comprising right cylindrical surfaces, the second portion having a right cylindrical surface of a first diameter defined as R_{CR}, one of the first and third portions having a right cylindrical surface of a diameter R₁, wherein R₁≧(R_{CR}+E), and the other of the first and third portions having a right cylindrical surface of a diameter R₂, wherein R₂≦(R_{CR}−E).

46. A method of adjusting the compression ratio of an internal combustion engine comprising:
reciprocating a piston in a cylinder between a top position and a bottom dead center position;
engaging and turning a compression ratio adjuster as the piston approaches the bottom dead center position;
coupling the compression ratio adjuster to a piston coupler;
storing torsional energy in a biasing member coupled to the piston coupler and to the compression ratio adjuster in response to turning the compression ratio adjuster;
turning the piston coupler with the stored torsional energy after the piston travels away from the bottom dead center position and toward the top position, the piston coupler comprising an eccentric coupling the piston to a connecting rod so as to adjust the top position and thereby the compression ratio upon turning the piston coupler.

47. A method according to claim 46 wherein the act of turning the piston coupler comprises turning the piston coupler at times when forces on a connecting rod coupling the piston to a crank shaft change from compression to tension or from tension to compression.

48. A method according to claim 46 wherein the act of turning the piston coupler comprises turning the piston coupler after the piston travels away from the bottom dead center position and before the piston reaches the top dead center position.

49. A method according to claim 46 wherein the act of turning the piston coupler comprises turning the piston coupler at times when the forces on the connecting rod coupling the piston to a crankshaft approach or reach a transition from compression forces to tension forces or from tension forces to compression forces.

50. A method of coupling a connecting rod to an eccentric of a piston pin, the piston pin being coupled to a piston that travels in a piston receiving cylinder between top dead center and bottom dead center positions, the connecting rod being coupled to a crank shaft such that when the crank shaft is driven by an internal combustion engine the connecting rod reciprocates and moves the piston in the piston cylinder, whereby pivoting the piston pin about a longitudinal axis of the piston pin rotates the eccentric relative to the connecting rod and adjusts the compression ratio, the method comprising;
threadedly coupling threads of a threaded portion of the eccentric of the piston pin to threads of a threaded piston pin receiving opening at an end portion of the connecting rod spaced from the crank shaft; and
wherein the act of threadedly coupling comprises threadedly coupling the threaded portion of the piston pin to threads of a piston pin receiving opening with threads that have a threaded angle α between side walls of the respective threads that prevents turning of the piston pin about the longitudinal axis of the piston pin due to the eccentricity torque and torque from other torque sources applied to the piston pin as the piston travels between top dead center and bottom dead center positions.

51. A method according to claim 50 comprising:
determining a maximum eccentricity torque for the internal combustion engine and the eccentricity of the eccentric of the piston pin;
selecting the thread angle α such that the torque at the threaded coupling is greater than the sum of the eccentricity torque and torque from such other torque sources by a safety margin.
